(19) United States
(12) Patent Application Publication
(10) Pub. No.: US 2011/0114496 A1
(43) Pub. Date: May 19, 2011

(54) Electrochemical Devices, Systems, and Methods

(76) Inventors: Robert B. Dopp, Marietta, GA (US); Sharon Z. Stein, Marietta, GA (US)

(21) Appl. No.: 13/054,159

(22) PCT Filed: Jul. 13, 2009
(86) PCT No.: PCT/US2009/050430

§ 371 Date: Jan. 14, 2011

Related U.S. Application Data
(60) Provisional application No. 61/080,909, filed on Jul. 15, 2008.
(60) Provisional application No. 61/080,900, filed on Jul. 15, 2008.
(60) Provisional application No. 61/098,719, filed on Sep. 19, 2008.
(60) Provisional application No. 61/150,775, filed on Feb. 8, 2009.
(60) Provisional application No. 61/187,167, filed on Jun. 15, 2009.

(51) Int. Cl. C25B 11/06; C25D 15/00; B82Y 99/00

(52) U.S. Cl. 205/109; 204/290.01; 204/290.14; 977/773

(57) ABSTRACT

The fabrication of electrodes and electrode surfaces as well as devices that use the electrodes are described. In an example, a metallic powder is coplated with an electroplating solution to trap the particles in an electroplated metallic layer on a substrate, for example a reticular substrate that permits flow therethrough. Applications include electrolysis cells, fuel cells and bifunctional gas electrodes. In an example, fuels are supplied to the electrodes as anolyte and catholyte mixtures composed of finely divided bubbles of hydrogen and oxygen respectively within an alkaline electrolyte.

### RELATED APPLICATION DATA

This application claims priority to U.S. Provisional Patent Application Ser. No. 61/080,900 for Co-Plating Of Nano Catalytic Particles Onto Conductive Supporting Surfaces And Methods Of Co-Plating filed Jul. 15, 2008; U.S. Provisional Patent Application Ser. No. 61/080,909 for Three-Dimensional Electrochemical Surface Without Free-Floating Catalysts filed Jul. 15, 2008; U.S. Provisional Patent Application Ser. No. 61/098,719 for High Efficiency Water Electrolyzer filed Sep. 19, 2008; U.S. Provisional Patent Application Ser. No. 61/150,775 for High Powered 3D Alkaline Fuel Cell filed Feb. 8, 2009; and U.S. Provisional Patent Application Ser. No. 61/187,167 for Carbonless Bifunctional Electrode filed Jun. 15, 2009 each of which is hereby incorporated by reference in its entirety herein.

### BACKGROUND

The following patent documents are hereby incorporated by reference in their entireties herein: U.S. patent application Ser. No. 12/045,625 to Dopp et. al. filed Mar. 10, 2008 for High Rate Electrochemical Device; U.S. Pat. No. 7,491,309 to Peter et. al. filed Dec. 21, 2005 for System and Method for the Production of Hydrogen; U.S. Patent Publication 20070166602 to Burchardt, filed Dec. 6, 2006 for Bifunctional Air Electrode; and U.S. Pat. No. 5,306,579, to Shepard et. al. filed Oct. 30, 1992 for Bifunctional Metal-Air Electrode.

When used in a fuel cell, hydrogen gas is a renewable fuel that produces zero emissions. Over 95% of the hydrogen used today is being produced by steam reformation of petroleum. This method produces nine pounds of greenhouse gases for every pound of hydrogen produced. The remaining 5% of hydrogen production is from water electrolysis, which involves splitting of a water molecule, where the only byproduct is oxygen gas and no greenhouse gasses are produced. There are several electrolyzer designs in use today including the proton exchange membrane technology which is essentially the same as a hydrogen-oxygen fuel cell run in reverse to use energy to split water rather than combine hydrogen and oxygen to generate energy. The other prominent design is the alkaline electrolyzer where plates of metal, usually stainless steel, are immersed in alkaline water, usually KOH or NaOH. Electricity is applied to produce hydrogen at the negative terminal and oxygen at the positive terminal.

The 2010 Department of Energy (DoE) target for fuel cells is to exceed 75% energy efficiency for an entire plant. The efficiency is the energy within the resulting hydrogen divided by the energy used to make that hydrogen. Typically, however, even a well-designed electrolysis apparatus suffers 8% parasitic losses due to heating, pumping, valves, sensors and controllers within the system. The current applied to the electrolysis system determines the quantity of hydrogen. The efficiency of the hydrogen production process, however, is determined by the voltage in the hydrolysis cell, namely, energy Efficiency (EE)=1.482/Vcell. A more efficient electrode will have a lower cell voltage and allow more cells to be driven in series within any single voltage limitation.

Metal-Air batteries have the highest energy density and specific energy of all battery systems. This is due to the use of ambient oxygen for the cathodic fuel, which reacts within the battery at a thin catalytic layer. All other battery systems must include the cathodic fuel, which takes space and volume to contain. An example of a metal air system is Zinc Air with a cathodic reaction of H₂O+½O₂+2e⁻→2OH⁻ and an anodic reaction of Zn+2OH⁻→ZnO+H₂O+2e⁻. This type of battery runs until all the zinc is oxidized.

The reverse reactions are electrochemically possible with proper catalyst choices. The problem others have encountered is the reverse cathodic reaction of 2OH⁻→H₂O+½O₂+2e⁻ due to the nascent oxygen generated within the electrode's body. This nascent oxygen has a great affinity for any electron donor. If it encounters another nascent oxygen, it will quickly form a diatomic molecule of O₂. If it encounters a carbon atom it forms either CO or CO₂ which dissolves into the alkaline electrolyte forming potassium carbonate (KCO₃) from the reaction 2KOH+CO₂→K₂CO₃+H₂O. That reaction consumes a hydroxyl ion (OH⁻) and depletes the electrolyte. After only a few cycles the “rechargeable” zinc air cell ceases to function for lack of hydroxyls.

### EMBODIMENTS OF THE DISCLOSED SUBJECT MATTER

First disclosed herein are various embodiments of devices, systems, and methods related to a novel way to achieve a coating of nano and mixtures of nano and micron scale particles onto a current collecting surface electrode. A high surface area coating with catalytic properties may be useful in the water electrolysis, fuel cell, and applications. Embodiments will now be described with reference to the drawings, wherein like reference numbers indicate like parts throughout the several views.

A three-component high-surface area electrode is described. In embodiments, the electrode comprises:
A first component may be, substantially, a substrate such as a plate or other structure having a regular or complex geometry and having a smooth or rough surface and consisting of transition metals including among others, nickel, iron, stainless steel, or silver. The first component may be defined by a reticular structure, a plate, a random textile, channeled, dendritic, foam, or self-similar patterned or unpatterned structure with internal channels or external grooves or pits, spines, fins, or any kind of structure that permit fluids or fluid components to reach a surface or surfaces thereof, including a surface of a material layered on the substrate, either by convection, advection or diffusion.
A second component may be, substantially, a component of transition metals including among others, nickel, gold or silver attached to the first component, for example by electroplating.
A third component may be, substantially, metal particles; preferably nano-sized metal particles and/or mixed nano-micron sized particles of transition metals including among others iron, tin, nickel, silver, manganese, cobalt and alloys and oxides of these metals.
The third component may be partially embedded in the second component and may be principally of nano and/or micron sized particles partially embedded in the second component but exposed such that when the completed electrode is immersed in electrolyte, the third component is in intimate contact with the electrolyte. The third component may be partially covered by the second component but, due to the second component's overlying the third component closely, so conforming to the third component size and shape that the third component imparts a roughness to the surface of the second component that is responsive to the size and shape of the third component.

This electrode may be used in electrochemical devices, including, but not limited to, hydrogen-generating electrodes in a water electrolyzer system and fuel cells. The very high surface area, with a high percentage of surface atoms, may render the surface highly catalytic to the splitting of water molecules in the presence of electrical energy. Typical electrodes having a lower surface area may operate at a disadvantage in terms of efficiency, cost, size, output, and in other ways. These disadvantages hamper the competitiveness of electrolysis compared to competing technologies such as steam-reformed petroleum. The same disadvantages hamper the competitiveness of fuel cells in power generation and other applications.

The disclosed subject matter may provide other advantages as well, including stability over extended operational duration, cost, fabrication speed, reliability, scalability and flexibility to a wide variety of sizes and shapes, higher rates of power/hydrogen production, stability both on the anode and cathode electrodes, and higher electrical efficiency.

The co-plated nanoparticle coatings may contain nanoparticles with a diameter of less than 1000 nm. Particles below this size may be referred to as “nanoparticles”. In embodiments, a mixture of sizes may be beneficial. For example, coplating a mixture of 20 μm particles with 10 nm particles results in a 2000% increase in the exposed surface area of the reactive surface as compared to coplating 10 nm particles alone. The result is a great increase in the reactive surface and the catalytic effectiveness of that surface.

The embodiment electrodes may be used to produce hydrogen and oxygen either as individual or mixed gases, depending upon the specific arrangement of the individual cells. The source of the electricity may also include sources such as, but not limited to, rectified electricity from the power grid, electricity directly from photo voltaic cells, electricity from a solar/thermal arrangement or electricity from geothermal sources. The resulting gases may be used as a fuel in electrochemical cells or mixed with other flammable gasses to produce synthetic fuels (i.e., synfuels). Embodiment electrodes may also be used in electrochemical cells and fuel cells or any other similar type of device.

The disclosed subject matter includes systems, devices, and methods for providing an electrode with a catalyst-coated three-dimensional reaction volume without the use of free-floating catalyst powders in a full cell design. This volume may be provided as a reticular member with a surface that is augmented at all surface points of the reticulum including interstitial surfaces. The electrode may be used with multiple cells connected by one or more gas manifolds configured to permit a system of a desired scale. In a vertical, side-by-side, orientation of the electrodes, ions may enter from one side and gasses may escape from the opposite side of the electrode. This flow-through configuration offers the potential for a very high rate, compact, electrolyzer for the production of hydrogen (and oxygen) from water and for high power density fuel cells.

An electrolyzer unit comprising pairs of catalyst-coated high-surface area three-dimensional (3D) electrodes electrolyze water efficiently at high rates. The electrolyzing unit includes reticulate metal elements, for example, thick plates that can be made of, for example metallic foam, or layers of porous sheet or screens with spacers or any other suitable structure. The reticular elements may be coated with catalytic metal particles, preferably having sizes down to the nanoscale. The reticulate metal plate preferably includes a large void volume to allow both convection and diffusion flow of fluid (electrolyte), ions, and resulting gasses. At least one advantage is that the electrode may be operated at lower voltages and very high currents (rates), which in turn leads to large amounts of hydrogen (and oxygen) being produced. The system may also be easily scaled to large production electrolysis arrays.

In a variation, a water electrolysis cell has vertical electrodes in adjacent cell halves standing next to each other with a separator between them. Electrolyte is allowed to flood both halves of the cell with hydrogen freely flowing from the cathode (electron accepting) and oxygen from the anode (electron liberating) portion of the device. Pumping of the electrolyte is not essential, but may be helpful depending on the overall structure and size of the system. In a preferred embodiment, the flow of gas due to buoyancy provides convective flushing and mixing as well as transport of gases for collection. Gas separation may be provided in isolation so that there is no need for any additional means for gas separation. Ions and water move through the separator unimpeded by gas bubbles, which escape from the opposite side of the electrodes by buoyancy

The cell may use electricity to produce hydrogen and oxygen either as individual or mixed gases depending upon the specific arrangement of the cell. The source of the electricity may also include many sources such as, but not limited to, rectified electricity from the power grid, electricity directly from photovoltaic cells, electricity from a solar/thermal arrangement or electricity from geothermal sources. The resulting gases may be used as a fuel in electrochemical cells or mixed with other flammable gasses to produce synthetic fuels (e.g., synfuels).

In the embodiments disclosed, fuel cells produce electricity from fuel (on the anode side) and an oxidant (on the cathode side), which react in the presence of an electrolyte. The reactant gasses flow into the cell, and the reaction products flow out of it, while the electrolyte remains within it. The fuel cells may operate virtually continuously as long as the necessary flows are maintained. In embodiments, the fuel cell's electrodes are catalytic and are not modified by the process of energy conversion.

Many combinations of fuel and oxidant may be used to power the fuel cell embodiments. A hydrogen fuel cell can use hydrogen as fuel and oxygen (for example, from the air) as oxidant. Other fuels include hydrocarbons, alcohols and ammonia. Other oxidants include oxygen, air, chlorine and chlorine dioxide. Fuel cells may operate with higher efficiencies than traditional combustion engines due to their lower thermal energy loss. In addition, emission of greenhouse gasses from hydrogen fuel cells can be nonexistent.

Platinum is suitable for hydrogen oxidation and oxygen reduction in gas diffusion electrodes for a variety of fuel cells. However, the cost of a platinum deposited electrode, typically loaded anywhere from 2-8 mg/cm2, is widely considered to be a hurdle to widespread commercialization. With increasing demand for alternative energy sources by consumers, efficient catalysts, new fuel cell electrodes and designs must be discovered to alleviate the demand and expense of platinum.

Disclosed herein are various embodiments of devices, systems, and methods that provide and use a fixed surface three-dimensional reaction zone. In an embodiment, multiple cells are connected by a manifold providing a side-by-side orientation of electrodes. Ions enter from one side and gasses enter from the opposite side of the electrode. The configuration provides a high rate of conversion in a compact cell using hydrogen or other anode fuels and an oxidant such as oxygen.

Embodiments may include one or more basic units, each including a pair of electrodes of reticulate metal plates, for example metallic foam. The reticulate plates may have rough surfaces, preferably providing high surface area, such as, for example, achievable by coating with catalytic non-noble metal particles. Preferably such coatings include nanoparticles. The reticulate metal plate may include a large void volume to allow the free flow of ions and resulting gasses. The basic unit may be sized and/or replicated to form systems of any scale.

In an embodiment an alkaline fuel cell device has adjacent electrodes with a separator between them such that gas-filled electrolyte floods both halves of the cell with fine hydrogen bubbles within the anolyte and oxygen bubbles within the catholyte. Pumping of the electrolyte may be done with gas mixing achieved by any suitable method including, but not limited to, forcing through an atomizing diffusion stone, a sparger, ultrasonic agitation and/or other high-sheer methods. Additives may also be used to maintain the suspension without foaming.

With high surface area per unit volume, there is a large supply of surface to support the non-noble metallic nano catalysts to achieve high efficiency operation without the use of expensive catalysts. The plates of the fuel cell may be in a variety of orientations according to the particular application.

In a preferred configuration where oxygen is obtained from the air, scrubbing of carbon dioxide from the air may be done by absorption onto an alkaline sponge surface, forming potash in the process. For automotive applications, this would result in a negative carbon emission number.

Fuel cells are typically run at a constant rate due to moisture balance issues above or below some optimum rate. By using anolyte/catholyte fuel sources and totally flooded electrodes, moisture balance issues are mitigated or avoided. Thus, embodiments of fuel cells disclosed may be run at a variety of rates, potentially ranging from zero to a kinetic upper limit.

Embodiments of electrolyzers are also disclosed in that the embodiments may be employed as electrolyzers to produce hydrogen and oxygen. In an embodiment, a same system is used for both applications, namely, to store electrical energy and later to produce electrical output as a fuel cell.

Embodiments of a high-surface area three-dimensional electrode include a porous or reticulate metal plate, which may be coated with catalytic metal particles, preferably non-noble and at the nanoscale. Embodiments of a fuel cell have cathode half-cells that consume oxygen in a gaseous form either from the environment or an enriched oxygen gas-stream, while an anode half-cell is fed an anolyte composed of hydrogen gas as fine bubbles within a flowing electrolyte. The electrolyte may be alkaline or acidic depending upon the catalysts used on the electrodes. Preferably the electrolyte is an aqueous solution of about 33% KOH. The cathode is composed of a gas diffusion electrode which is essentially a two dimensional membrane, for example of a type often used in metal-air batteries. Although such membranes may be porous, as described for example in U.S. Pat. No. 5,378,562, hereby incorporated by reference in its entirety, a hydrophobic binder may leave the surface partially dry and partially wetted.

In other embodiments, a fuel cell includes the cathode half-cell and the anode half-cell with high internal surface area and void volume in a flow-through, fully flooded electrode configuration. Both halves of the fuel cell are fueled using an electrolyte containing fine gas bubbles within the flowing electrolyte. The anode contains a fuel to be oxidized such as hydrogen and the cathode contains an oxidant such as oxygen gas.

The electrolyte may be alkaline or acidic depending upon the catalysts used on the electrodes. In an example, the electrolyte is an aqueous solution of about 33% KOH. The electrodes may be composed of reticulate, foam, fibrous or other high void-volume metal mat and may be coated with nano-sized catalysts to increase the electrochemical activity.

In other embodiments, half-cells may be folded into a cylinder with the cathode half on the inside and anode on the outside. This structure may be used to provide a larger surface area for the anode, where twice the volume of gas may react and the catalysis may be less than that of the cathode half.

The anolyte may be composed of an aqueous solution of ammonia dissolved within the KOH electrolyte. In this case, the anode electrode may split off the hydrogens from the ammonia molecule, as well as function as the anode of the fuel cell.

In each of these embodiments of the disclosed electrochemical device, oxygen reacts at the cathodic, charge accepting half-cell, where electrons are consumed and hydroxyl ions generated on that electrode by the general reaction of ½O2+H2O+2e−→2OH−. On the anodic electrode, which liberates electrons, hydroxyls are consumed by H2+2OH−→2H2O+2e−. Excess gasses can recirculate, being controlled at some approximately optimum level by making up lost gasses in a separate compartment where the concentration of the gasses is held constant.

This disclosed subject matter includes a technique for the attachment and adhesion of catalysts to a conductive surface rendering that surface more catalytically active. The disclosed subject matter also includes methods for coating hidden surfaces of a reticulate electrode to provide a three-dimensional high surface area electrode, for example, a porous gas-diffusion electrode and one that may contain no substantial carbon component. Embodiments may employ catalysts suitable for rechargeable metal-air batteries. Embodiments may provide electrodes for metal-air batteries.

The failure modes for rechargeable metal air batteries include:
Degradation of the reactive sites during the recharging reaction.
Loss of hydroxyls from the CO₂ resulting from the side reaction of carbon with nascent oxygen.

This disclosed subject matter uses a coating method to fill the interior of a reticulate metallic current collector with catalyzing powders and polytetrafluoroethylene (PTFE or Teflon®) powder. A method of fabricating an electrode may include compacting or otherwise compressing the resulting structure. A hydrophobic film may then be attached, such as by pressure lamination, to it form a gas electrode. The electrode may be substantially carbon free or at least free of reactive carbon or carbon sited such as to reactive. For example carbon may be used to provide mechanical properties and be isolated from being chemically functional or vulnerable. This electrode, when used in a rechargeable metal air cell, may not consume the hydroxyls within the electrolyte as a result of the nascent oxygen only having its neighboring oxygen atoms to combine with.

A three-component high-surface area electrode is described which is further modified as described herein to provide an electrode member for metal-air batteries. In embodiments, the electrode comprises:
A first component may be, substantially, a solid metallic plate consisting of transition metals including among others, nickel, iron, stainless steel, or silver. The first component defines a reticular structure with channels, for example random channels, throughout. Examples are a metal sponge or one or more layers of woven or non-woven metal fabric.
A second component may be, substantially, a component of transition metals including among others, nickel, gold or silver attached to the first component, for example by electroplating.
A third component may be, metal particles; preferably nano-sized metal particles and mixed nano-micron sized particles of transition metals including among others iron, tin, nickel, silver, manganese, cobalt and alloys and oxides of these metals.
This third component may be partially embedded in the second components and may be principally of nano and/or micron sized particles partially embedded in the second component but exposed such that when the completed electrode is immersed in electrolyte, the third component is in intimate contact with the electrolyte
A fourth component is a non-wettable material such as Teflon that is effectively distributed in the reticulum to provide a surface along which gases can diffuse into the reticulum and provide gas exchange at all points of the second and third component surface.
Additional components may be included in an electrode structure, for example, a Teflon barrier and a diffuser as typically provided in metal air batteries.

The co-electroplated nanoparticle coatings may contain nanoparticles with a diameter of less than 1000 nm. Particles below this micron limit are typically referred to as “nanoparticles” or nano-scale particles. In one embodiment, a mixture of sizes may be beneficial. For example, in an embodiment, 20 μm particles are mixed with 10 nm particles to provide a substantial increase in the exposed surface area of the reactive surface. The result is a great increase in the reactive surface and the catalytic behavior of that surface.

Although the term “layer” is used herein, it is not intended to limit the disclosed embodiments necessarily to layers in the sense of being fully stratified and segregated. For example, nanoparticles may be embedded throughout the electroplated layer as well as bound to, but on the surface of the electroplated layer. Thus, by using the term “layer” the disclosed subject matter is not limited to segregated or fully stratified layers.

Also disclosed are various embodiments of devices, systems, and methods relating catalyst-coated three-dimensional reaction zone without the use of free-floating catalyst powders in a full cell design. Specifically, the use of this coating process to build a carbon-free bifunctional gas electrode is described.

According to embodiments of the disclosed subject matter, a carbon free air-electrode has a porous conductor having a rough surface. The porous conduct surface has a hydrophobic web distributed throughout the porous conductor. The conductor may be of a metal substrate with a multiphase coating including nanoparticles, which create the roughness and define the degree of roughness. The substrate surface may be created by coplating particles of uniform or mixed size along with the hydrophobic material, e.g., PTFE. Thus, the surface may include a multiphase coating including nanoparticles embedded in a metallic matrix as well as a fibrillated web of hydrophobic material. The surface may have exposed surfaces of nanoparticles embedded in the metallic matrix. The porous conductor may be a metal reticulum. The conductor may be a generally planar structure and the density of hydrophobic web may be higher on one side of the conductor than on the opposite side of the conductor. The nanoparticles may be of, or include, at least first and second materials, and a ratio of the density of nanoparticles of the first material to the second material on one side of the conductor is different from a ratio of nanoparticles of the first material to the second material on the other side of the conductor such as to provide catalytic properties that are different on different sides of the electrode. A hydrophobic sheet and diffuser may be attached to one side of the conductor.

According to embodiments of the disclosed subject matter, a method of forming an electrode, includes suspending metal nanoparticles and a hydrophobic material in an electrolytic plating solution and electroplating a metal electrode substrate placed in the plating solution for a period of time until a surface having exposed nanoparticles and exposed hydrophobic material thereon develops. The nanoparticles may be of nickel, iron, cobalt, silver, tin, chromium, manganese, palladium, platinum, combinations thereof, alloys thereof or oxides thereof. The hydrophobic material is a PTFE powder. The method may further include compressing the substrate following the electroplating such that the hydrophobic material forms a fibrous web. The substrate may be reticular member. The substrate may be electrically conductive. The method may further include compressing the substrate following the electroplating such that the hydrophobic material forms a fibrous web. The electroplating may include electroplating nickel, copper, gold, silver or tin.

According to embodiments, the disclosed subject matter includes an electrode with a substrate having a multiphase layer on thereon. The multiphase layer includes particles and a metal matrix. At least some of the particles are at least partially embedded in the metal matrix and some may be, partially exposed. In some embodiments, all of the particles may be covered with a matrix layer of some thickness but at least of the particles that are covered have a layer of matrix thereon which is sufficiently thin that the size of the covered particles determines the roughness of the surface. That is, the smallest features, including radii of curvature, gaps between pillars or bumps, pits, mounds, etc., are on the order of the size of the covered particles. Thus, at least the embedded or partially exposed surface of the particles defines, at least in part, in the aggregate, a catalytically active surface of the electrode. Many particles may be thoroughly embedded in the matrix such that they do not contribute to the final surface roughness, but this may be a result of how the surface is fabricated. The surface itself may be described as a product of a process of coplating as described by any of the disclosed method embodiments in the present specification. In any of the embodiments disclosed, the particles may be of uniform size, a distribution of sizes, or multiple discrete sizes.

The metal matrix itself may also contribute to the total area of catalytic surface. Roughness imparted to the metal matrix by the particles embedded therein may enhance the surface area of the metal matrix portion of the total surface or it may, in some embodiments, define all of the area, if the particles are all covered by the matrix. In an example, the metal matrix is formed by electroplating and the particles are attached to, or embedded in the matrix (or both) by coplating. The electrode has an electrical terminal connected to the substrate. The substrate is configured to collect charge carriers from the particles over the catalytically active surface and deliver them to the electrical terminal. At least some of the particles have a maximum dimension of less than 1 micron in diameter with the bulk of the particles below 50 nm and preferably below 20 nm.

The particles may be of a metal. Depending on the structure of the substrate, the substrate may be substantially formed of cold-rolled steel, stainless steel, nickel, copper, brass, silver or alloys thereof. The substrate may have any of a large variety of shapes, as described elsewhere herein, for example, it may be at least partly, a porous structure have a substantially isotropic void volume. Note that the substrate may include multiple components rather than a single material. The substrate may include metal foam where the metal matrix covers at least the interstitial spaces of the metal foam. The substrate may define a reticulum. The particles may be, or include, nano-scale powders of transition metals of groups 3-16. The particles may be nano-scale powders of nickel, iron, cobalt, silver, tin, chromium, manganese, palladium, platinum, combinations thereof, alloys thereof or oxides thereof. The particles may be mostly metal particles having a diameter of less than about 100 nm. The particles may be mostly metal particles comprises particles have diameters ranging between 20 micron to 10 nm.

According to embodiments, the disclosed subject matter includes an electrode fabricated by a process, comprising: suspending metal nanoparticles in an electrolytic plating solution and electroplating a metal electrode substrate placed in the plating solution for a period of time until a surface of nano-scale roughness is achieved. The nanoparticles may be of nickel, iron, cobalt, silver, tin, chromium, manganese, palladium, platinum, combinations thereof, alloys thereof or oxides thereof. The electroplating may include applying a pulsed voltage to the substrate of such magnitude and such waveform that, in combination with the density of the suspension and the sizes of the nanoparticles, a surface characterized by nanoparticles at least partially embedded in a metal matrix of electrodeposited metal results and such that the partially exposed surface of the particles and the surface of the electrolytically deposited metal define, in the aggregate, a catalytically active surface. The general bright nickel bath parameters of this pulsed electroplating may be:
An anode of pure nickel
A duty cycle (on time) from 60% to 80%, preferably about 50%.
An “on” pulse between 100 and 300 mA/cm², preferably about 150 mA/cm².
A reverse pulse of about 5% duty cycle and about −400 mA/cm².
The electrolyte bath may be agitated or mixed.
A pH may be below 6 and may be as low as 2 and is preferably about 4.5.
An electrolyte bath temperature may be between 40 and 70 degrees C. and preferably about 60 degrees C.
A total loading of suspended particles may be about 1% of the bath weight.

The metal electrode substrate may define a reticular member with a substantial void volume. The metal electrode may define a sieve. The electroplating may include electroplating nickel, copper, gold, silver or tin. The nanoparticles may have a mean size of less than about 100 nm. The nanoparticles may be a mixture of effective diameters from 20 microns to 10 nm.

According to embodiments, the disclosed subject matter includes a method of making an electrode. The method includes suspending metal nanoparticles in an electrolytic plating solution. The method further includes electroplating a metal electrode substrate placed in the plating solution for a period of time until a surface of nano-scale roughness is achieved. The nanoparticles may be of nickel, iron, cobalt, silver, tin, chromium, manganese, palladium, platinum, combinations thereof, alloys thereof or oxides thereof. The electroplating may include applying a pulsed voltage to the substrate of such magnitude and such waveform that, in combination with the density of the suspension and the sizes of the nanoparticles, a surface characterized by nanoparticles at least partially embedded in a metal matrix of electrodeposited metal results and such that the partially exposed surface of the particles and the surface of the electrolytically deposited metal define, in the aggregate, a catalytically active surface. The general bright nickel bath parameters of this pulsed electroplating may be:
An anode of pure nickel
A duty cycle (on time) from 60% to 80%, preferably about 50%.
An “on” pulse between 100 and 300 mA/cm², preferably about 150 mA/cm².
A reverse pulse of about 5% duty cycle and about −400 mA/cm².
The electroplating bath may be agitated or mixed.
A pH may be below 6 and may be as low as 2 and is preferably about 4.5.
An electroplating bath temperature may be between 40 and 70 degrees C. and preferably about 60 degrees C.
A total loading of suspended particles may be about 1% of the bath weight.

The metal electrode substrate may define a reticular member with a substantial void volume. The metal electrode may define a sieve. The electroplating may include electroplating nickel, copper, gold, silver or tin. The nanoparticles may have a mean size of less than about 100 nm. The nanoparticles may be a mixture of effective diameters from 20 microns to 10 nm. The disclosed subject matter includes electrodes formed by any of the methods disclosed herein.

According to embodiments, the disclosed subject matter includes an electrochemical device with first and second substrate members each having at least one channel with a rough surface lining the channel. The rough surface has an exposed catalyst. Each substrate member has first and second opposite sides, at least one of the channels having at least one opening on each of the opposite sides. A vessel is provided and adapted to hold an electrolyte, the substrate members being positioned in the vessel. A separator, which is porous to ions but effective to resist the flow of gas bubbles thereacross, is positioned between the first and second substrate member such that the substrate member first sides are adjacent the separator. Each of the first and second substrate members has an electrical terminal. The substrate members and separator are further arranged in the vessel such as to define two separate chambers divided by the substrate members and separator. A gas outlet is connected to each of the separate chambers.

The separator may be a membrane. Each of the substrate members may be a reticular structure with multiple channels. The rough surface may include a coating multiphase coating include nanoparticles attached to a metal matrix. The rough surface may include a coating multiphase coating include nanoparticles attached to, an embedded in, a metal matrix. The rough surface may include a coating multiphase coating include particles attached to, an embedded in, a metal matrix. The rough surface may include a coating multiphase coating that include particles having a range of sizes attached to, an embedded in, a metal matrix. At least one of the first and second substrate members may be substantially formed of steel, stainless steel, nickel, copper, brass, silver or alloys thereof. One or all of the first and second substrate members may be a metal foam. Multiple additional first substrate members and multiple additional second substrate members may be provided. These may be attached to a separator, which is then accordion-folded defining flat and bent portions such that the substrate members are attached on opposite sides of the flat portions. In this configuration, the substrates and separator may define a high area separator between the chambers.

According to embodiments, the disclosed subject matter includes a fuel cell device with first and second half-cells, each having a chamber containing an electrode member including a metallic reticulum configured to be permeated by a respective reaction medium. The metallic reticulum has a surface including electro-deposited metal particles. The first half-cell electrode member is permeated by a catholyte having bubbles of cathodic fuel. The second half-cell electrode member is permeated by an anolyte having bubbles of anodic fuel. Fluid conveyances are provided and configured to continuously convey fresh catholyte and anolyte to the first and second half-cell chambers, respectively.

The metallic reticulum may include a current collector. The metallic reticulum may include a metal foam. The first and second half-cells may be separated by a separator that is permeable to hydroxyl ions and water. The first and second half-cells may be cylindrical in shape with the first positioned within the second. The metallic reticulum may include a transition metal or an alloy thereof. The metallic reticulum may include stainless steel, nickel or silver. The electro-deposited metal particles may include a substantial number having an effective diameter of less than about 100 nm.

The electro-deposited metal particles may include a substantial number having effective diameters in the range of 10 mm to 5 nm. At least a portion of the reactive metal particles may include nanoparticles having an oxide shell. The device may be configured to generate electricity from hydrogen within the anolyte and oxygen within the catholyte. The metallic reticulum may include a transition metal or an oxide thereof. The device may further include a first header configured to convey water containing a gaseous oxidizer to the first half-cell and other half-cells and a second header configured to convey water containing a gaseous fuel to the second half-cell and other half-cells. The device may include a first header configured to convey water containing a gaseous oxidizer to the first half-cell and other half-cells and a second header configured to convey water containing a gaseous fuel to the second half-cell and other half-cells, and further comprising pumps to control the flow of fluid in the headers via a feedback control mechanism to maintain a sufficient quantity of fuel and oxidizer to regulate an output fuel cell device.

According to embodiments, the disclosed subject matter includes a carbon free air-electrode with a porous conductor having a rough surface. A hydrophobic web is distributed throughout the porous conductor. The conductor may have a metal substrate with a multiphase coating including nanoparticles. The hydrophobic web may include PTFE. The hydrophobic web may include PTFE. The conductor may have a metal substrate with a multiphase coating including nanoparticles embedded in a metallic matrix the rough surface may include the exposed surfaces of nanoparticles embedded in the metallic matrix. The porous conductor may be a metal reticulum. The hydrophobic web may include PTFE. The conductor may be a generally planar structure and the density of hydrophobic web is higher on one side of the conductor than on the opposite side of the conductor. The conductor may be a generally planar structure, wherein the conductor may have a metal substrate with multiple coatings including nanoparticles embedded in a metallic matrix forming a rough surface that may include the exposed surfaces of nanoparticles embedded in the metallic matrix. The nanoparticles may be of at least first and second materials, and a ratio of the density of nanoparticles of the first material to the second material on one side of the conductor may be different from a ratio of nanoparticles of the first material to the second material on the other side of the conductor. A hydrophobic sheet and diffuser may be attached to one side of the conductor.

According to embodiments, the disclosed subject matter includes a method of forming an electrode. The method includes suspending metal nanoparticles and a hydrophobic material in an electrolytic plating solution and electroplating a metal electrode substrate placed in the plating solution for a period of time until a surface having exposed nanoparticles and exposed hydrophobic material thereon develops. The nanoparticles may be of nickel, iron, cobalt, silver, tin, chromium, manganese, palladium, platinum, combinations thereof, alloys thereof or oxides thereof. The hydrophobic material may be, or include, a PTFE powder. The method may further include compressing the substrate following the electroplating such that the hydrophobic material forms a fibrous web. The substrate may be, or include, an electrically conductive reticulum. The metal electrode substrate may be a reticular member with a substantial void volume. The metal electrode may form a sieve. The electroplating may include electroplating nickel, copper, gold, silver or tin. The nanoparticles may have a mean size of less than about 100 nm. The nanoparticles may have a mixture of effective diameters from 20 microns to 10 nm.

With the closed nature of the cells with fully flooded electrodes, moisture balance is necessarily dealt with externally to the cells. This allows for variable rate running of the fuel cell with no concerns regarding electrode flooding or drying as typical fuel cells always encounter.

According to embodiments, the disclosed subject matter includes an electrochemical device with first and second electrodes having voids with internal catalytic surfaces. A flow channel conveys electrolyte through the first electrode, then through a porous separator, then through the second electrode and back to the first electrode. A first gas outlet is positioned to capture gas at a point in the flow channel prior to the porous separator and a second gas outlet is positioned to capture gas at a point in the flow channel after the porous separator. A pump in the flow channel is configured to flow electrolyte such that a pressure developed across the porous separator lies below a bubble point of a gas passing through the first gas outlet. The flow channel may be filled with an electrolyte suitable for electrolytic generation of hydrogen and oxygen gas. Each of the first and second electrodes may include a substrate, a multiphase layer on the substrate including particles and a metal matrix. Each of the first and second electrodes may have a multiphase layer on the substrate including particles and a metal matrix wherein at least some of the particles are partially embedded in the metal matrix and partially exposed. The partially exposed surface of the particles may define, in the aggregate, a catalytically active surface of the electrode and wherein the at least some of the particles have a maximum dimension of less than 1 micron in diameter. The substrate may include metal foam and the metal matrix may cover interstitial spaces (the voids) in the metal foam. The substrate may be a reticulum. The particles may include nano-scale powders. The particles may include nano-scale powders of nickel, iron, cobalt, silver, tin, chromium, manganese, palladium, platinum, combinations thereof, alloys thereof or oxides thereof. The particles may of mixed sizes.

Note that a variation of any of the embodiments disclosed herein may be electrode surfaces using particles of larger size, for example micron or larger particles. The electrodes and other articles resulting therefrom are also included in the disclosed subject matter.

In any of the disclosed embodiments, a vibration motor may be used to vibrate the electrodes. The vibration frequencies may range from the sub 1 hertz up to ultrasonic frequencies. The vibrations have been found to provide more durable rates of electrolysis and power generation.

In any of the embodiments disclosed herein, particles other than catalyst material may be coplated along with or in a separate step according to any of the disclosed methods or processes. For example, particles of material that promotes conduction but which is not compatible with a desired electrolyte may be coplated in an operation prior to coplating the catalyst. Also, in another embodiment, the matrix metal may provide all of the catalytic surface and the particles may be used only to create the roughness of the surface. In such embodiments, particles that are incompatible with or less desirable as catalysts may be coplated according to any of the disclosed embodiments.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. The drawings, in some instances, represent additional embodiments as well as embodiments falling within the descriptions in the previous section.

FIG. 1 illustrates a Fluidized Bed Reactor half-cell according to embodiments of the disclosed subject matter.

FIG. 2 illustrates a flat current collector with nano catalysts co-plated on the surface according to embodiments of the disclosed subject matter.

FIG. 3 illustrates the use of coated plates to build a bipolar electrolyzer according to embodiments of the disclosed subject matter.

FIG. 4A illustrates a 3D electrode full cell with an electrode pair according to embodiments of the disclosed subject matter.

FIGS. 4B, 4C, 4D, and 4F illustrate electrode pairs separated by a separator according to various embodiments of the disclosed subject matter.

FIG. 4E illustrates an electrolytic device with electrode pairs separated by a separator according to embodiments of the disclosed subject matter.

FIGS. 4G and 4H illustrate a forced convection electrolyzer according to embodiments of the disclosed subject matter.

FIGS. 5A and 5B illustrate a full cell device outer body parts according to embodiments of the disclosed subject matter.

FIG. 6 illustrates a functional set of three 3D cells according to embodiments of the disclosed subject matter.

FIGS. 7A-7G illustrate a variety of electrode substrate and current carrier configurations for electrochemical devices according to embodiments of the disclosed subject matter.

FIG. 8A illustrates a coplating wave-shape according to embodiments of the disclosed subject matter.

FIG. 8B illustrates a switching system that applies a power source of load to one or more electrochemical devices to time-vary the power or load profile.

FIG. 9 is a graph of cell voltage versus current density of Example #1 compared to nickel and SS316.

FIG. 10 is a graph of cell energy efficiency versus current density of Example #1 compared to nickel and SS316.

FIG. 11 is a graph of cell energy efficiency versus current density of Example #1 compared to nickel and SS316 with QSI and GE comparison data included.

FIG. 12 is a graph showing hydrogen gas output is the plates are 225 cm² and a total electrolyzer voltage power supply is limited to 14 volts DC built from half-cell data.

FIG. 13 is a graph showing hydrogen gas output if the plates are 225 cm² and a total electrolyzer voltage power supply is limited to 14 volts DC built from full-cell data.

FIG. 14 is a bar graph comparing the Energy Efficiency of three designs at four current densities. This shows the effect of the 3D electrode alone with no co-plated catalysts.

FIG. 15 is a bar graph comparing the Energy Efficiency of three designs at four current densities. This shows the effect of the 3D electrode with co-plated catalysts attached to the inner surfaces of the foam nickel electrode. Under that condition it is superior to the Fluidized Bed Reactor on all loads.

FIG. 16 illustrates an air-breathing fuel cell according to embodiments of the disclosed subject matter.

FIG. 17 illustrates a catholyte/anolyte fuel cell according to embodiments of the disclosed subject matter.

FIGS. 18A to 18C shows a fuel cell according to yet another embodiment with circular cross-section for a pair of 3D half-cells according to embodiments of the disclosed subject matter.

FIG. 19 shows multiple cells joined by manifolds that distribute catholyte and anolyte to the multiple cells according to embodiments of the disclosed subject matter.

FIG. 20 illustrates a carbon-based gas electrode according to embodiments of the disclosed subject matter.

FIG. 21 illustrates a Zinc Air cell according to the prior art.

FIG. 22 illustrates a flat current collector with nano catalysts co-electroplated on the surface according to embodiments of the disclosed subject matter.

FIG. 23 illustrates a porous 3D coated electrode according to embodiments of the disclosed subject matter.

FIGS. 24A through 24D are a set of photographs of the coated 3D bifunctional electrode according to embodiments of the disclosed subject matter.

FIG. 25 illustrates a coated 3D bifunctional electrode in a bifunctional Zinc Air cell according to embodiments of the disclosed subject matter.

FIG. 26 illustrates a half-cell apparatus for testing air-breathing electrodes.

FIG. 27 is Voltammogram showing degradation of a standard air cathode due to anodic discharge.

### DETAILED DESCRIPTION OF THE DRAWINGS

Note that despite the presentation of the features of the disclosed subject matter in terms of electrolyzer embodiments, the disclosed subject matter is also applicable to power generating devices and other types of electrochemical conversion devices. All of the embodiments, with suitable modifications, can be applied to fuel cells, electrochemical cells, and other devices as well as electrolyzers.

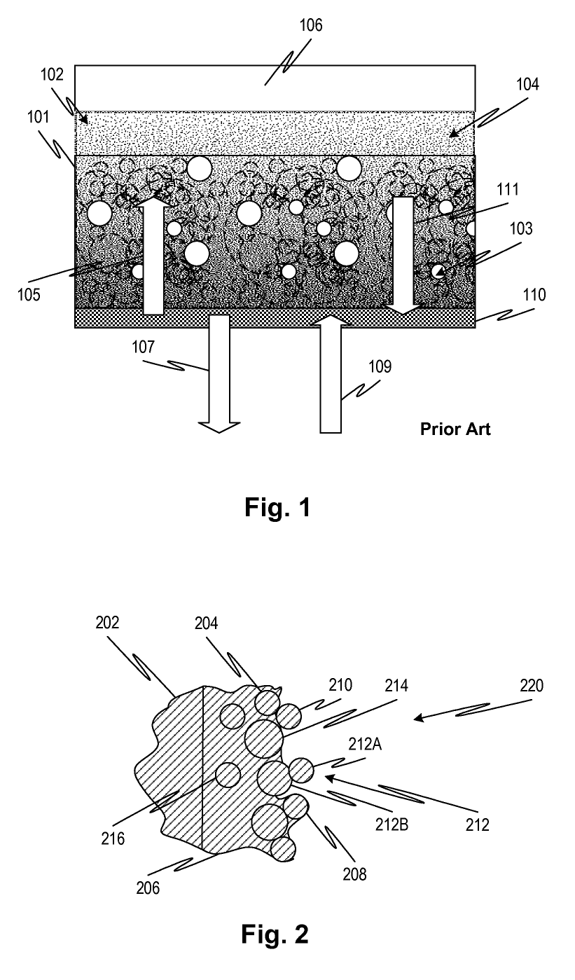

FIG. 1 illustrates a Fluidized Bed Reactor half-cell. In this prior-art example, a porous electrode is infused with nanoparticles and with nanoparticles suspended in electrolyte. Electrode 101 is porous, and permits electrolyte 104, carrying nanoparticles 102, to diffuse throughout void spaces 103 within the interior of the electrode 101. Water 109 passes through a separator membrane 110 into and through the void spaces 103 while hydroxyl ions 107 pass into the separator membrane 110 in the opposite direction as indicated by arrow 111. When a current is applied to the electrode 101, water in the electrolyte is split, producing hydrogen gas 105 which diffuses upwardly to escape and form an exiting volume of gas 106. The movement of hydrogen by buoyancy maintains fluidization within the chamber. Meanwhile, hydroxyl ions 107 move downwardly and permeate the separator membrane 110. When the system is running at its optimum, a fluidized bed reactor (FBR) is desirably established between the electrolyte, nano catalysts and the tiny hydrogen gas bubbles.

FBRs have been used to provide a large reaction surface area of exposed catalyst. In an FBR a gas or liquid is passed upwardly through the FBR with at a sufficient rate to cause suspension of the catalyst particles. The water-electrolysis FBR uses multiple phases including a liquid electrolyte, a solid nano catalyst suspended in that electrolyte by the gases produced in the reaction. Although these work very well for a short time, agglomeration of the nanoparticles presents a serious impediment to the development of larger, long running devices. FBR devices also require electrodes to be horizontal which requires the ions follow a long path to causing significant impedance losses.

FIG. 2 is a section view of a portion of a surface of a coated substrate 202 of arbitrary shape. The substrate 202 may be of any of a variety of metal groups or alloys thereof, including, but not limited to, cold rolled steel, stainless steel or nickel, silver, copper, brass, bronze or any other suitable metal. A second layer 206, which may be obtained by electroplating a metal, which may include nickel, gold, silver, tin, indium or alloys thereof. A third “layer” 204 includes particles which may be of one or more sizes or a range of sizes and may be attached or integrated with the second layer 206 by coplating as described below. The second layer 204 ensures that the exposed surface 220 has a roughness determined by the sizes of the smallest particles 204 coplated on the substrate. Some of the particles may be attached and mostly exposed on the surface as indicated at 210. Some of the particles may be fully embedded as indicated at 208 but thinly coated by the material of the second layer 206. As such the roughness of the exposed surface is still determined by the size of the particles such as the one indicated at 208. Some particles may be fully embedded 216. Some of the particles may be only slightly exposed as indicated at 214. Some particles may form compound structures 212 such as particles 212A and 212B, which are mutually attached. Much more complex surface features may be present and the illustration of FIG. 2 is illustrative and figurative. As such the disclosed subject matter is not limited to the features illustrated in, or identified in the discussion of, FIG. 2. Nor is the surface defined solely by the particles. The substrate itself may have substantial roughness as well. For example, the second and third layers may be formed on a pitted surface or a dendritic or otherwise roughened surface. The substrate roughness may be a regular or irregular (random) structure or a combination thereof.

The substrate first layer initial or final roughness may also be determined by a fabrication method thereof and may include a variety of fabrication methods. Substrates may be of a single layer employing no additional layers in embodiments to be combined with other features of the disclosed subject matter described herein. Thus, the layered structure of FIG. 2 is not the only manner of forming a rough surface. The substrate may be a plate, a reticulum, a woven and non-woven textile, a porous body, a body with internal channels having a regular, self-similar, or random surface augmentation on the internal channels. The substrate may be formed by lithographic techniques, material removal from single or multiphase precursors, machine etching, additive or subtractive techniques, etc.

In embodiments, the co-plated particles may be less than 1000 nanometers. In other embodiments, the particles may be less than 100 nanometers or less than 20 nanometers. In another embodiment, the third layer 204 may be composed of a mixture of different metals and different sizes ranging from low nanometers to as great as 50 micrometers. This nano catalyst may be any one of the transition metals, their alloys or oxides thereof. Preferably they may include nickel, cobalt, iron and manganese among others.

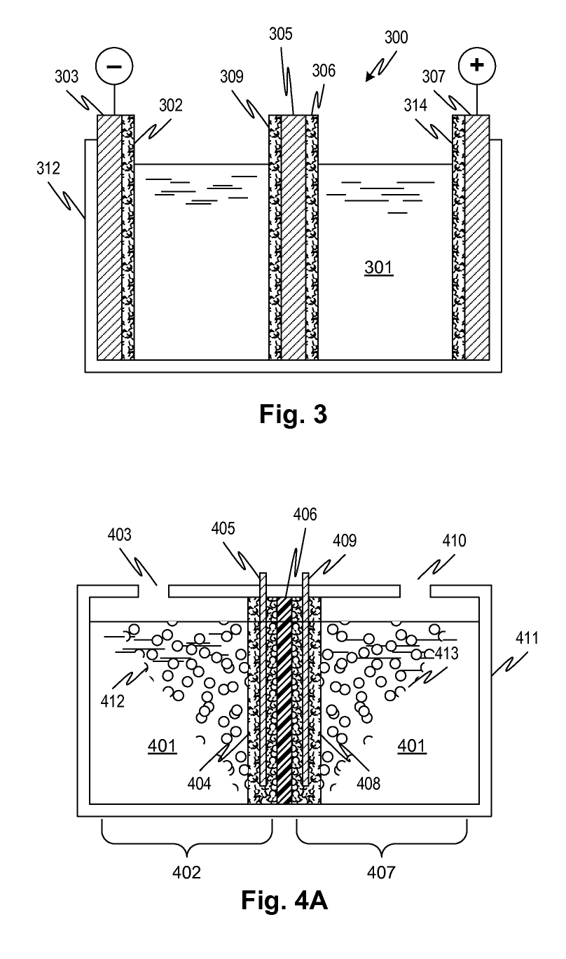

FIG. 3 illustrates an application of the layered structure of the electrode 200 described above. Shown is a water electrolyzer 300 in section. The electrolyzer 300 includes a plastic vessel 312 which may be a rectilinear box and capable of tolerating 150 degrees Celsius and the presence of nascent oxygen and preferably otherwise stable in highly caustic environments such as 33% KOH electroplating bath 301. In embodiments, Teflon, Noryl and other suitable plastics may be used for the vessel 312. A coating layer 302, which may be as described above with reference to FIG. 2, is provided on a first electrode substrate 303 as well as a similar coating 314 on an electrode 307. Similarly coating layers 306 are provided on a substrate 305, which acts as a bi-polar plate.

The 303 is a mono-polar plate. Hydrogen gas is produced at the catalyst surfaces 302 of the mono-polar plate 303. The reaction catalytic surface 302 is, in principal part, 2H₂O+2e⁻→H₂+2OH⁻. The hydrogen gas escapes by buoyancy while the hydroxyl ions (OH⁻) diffuse across to a reaction surface 309 of a bipolar plate 305. On the surface 309, the hydroxyl reacts to form oxygen gas by 2OH⁻→½ O₂+H₂O+2e⁻. The gas escapes thorough buoyancy while the electron passes through the bipolar plate 305. On surface of plate 306, the hydrogen generating reaction takes place and on surface 314 connected to the mono-polar plate 307, whose polarity is positive, the oxygen generating reaction takes place. In other embodiments, bipolar plate may be repeated with as many plates as one wishes to include, ending with the monopolar plate 307 where the liberated electron is allowed to escape the system into the positive pole of the power supply. The output from this type of electrolyzer produces mixed hydrogen and oxygen in a stoichiometric mixture. The addition of a separator between each plate can produce separated gasses if desired.

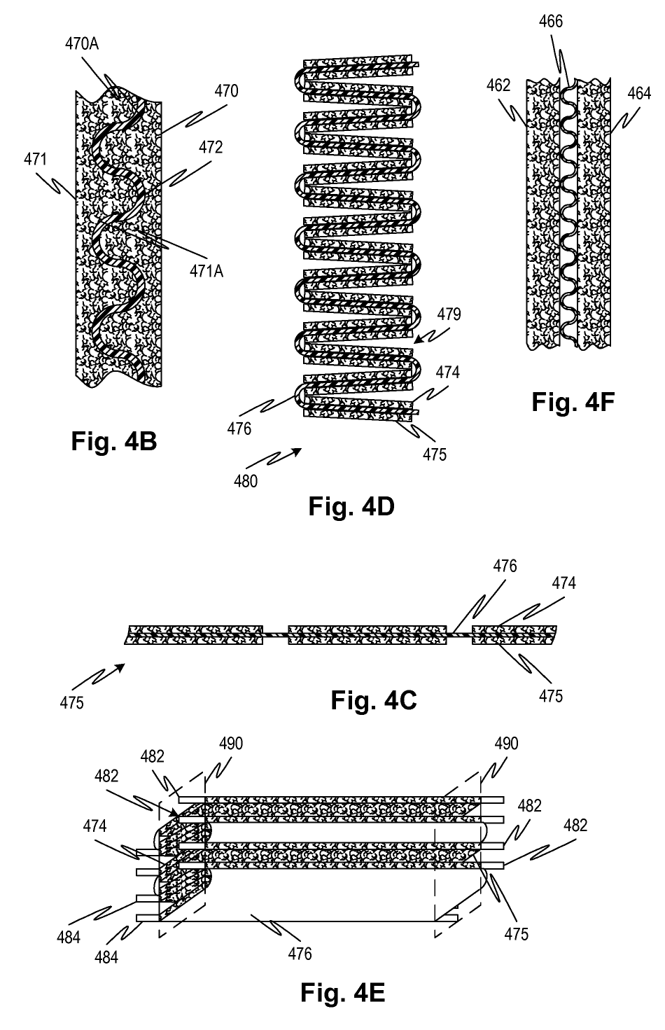

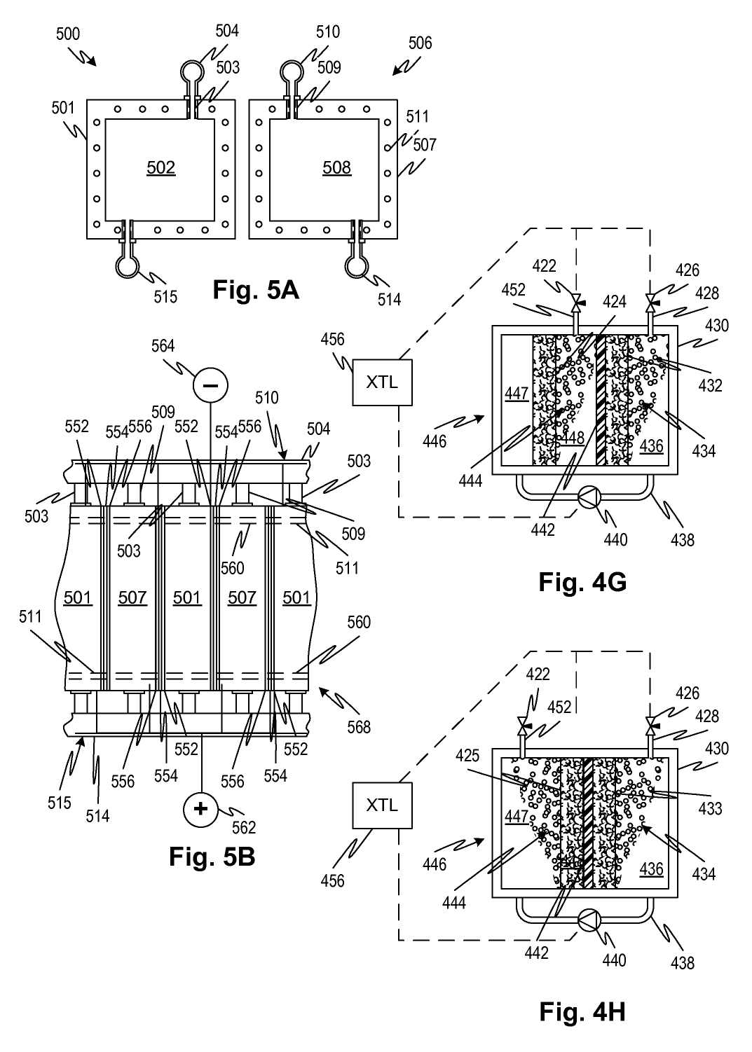

FIG. 4A illustrates a 3D monopolar electrode pair 402/407. The illustration shows two electrodes 404 and 408 and a separator 406. The electrodes are coated with a catalyst as described above which is adhered to the electrodes, which are preferably surface augmented, such as a reticular member. No free-flowing catalyst is present in the system. In general, the embodiment of FIG. 4A offers a much more stable and easily controlled reactor as compared to the FBR of FIG. 1. The catalyst coating may be achieved through co-deposition with metal plating, most preferably nickel. This is accomplished in a flowing apparatus to deposit the coating on all surfaces into the depth of metal or carbon foam substrate.

The co-plated nanoparticle coatings may contain nanoparticles with a diameter of less than 1000 nm and more preferably less than 50 nm in diameter. Particles below this micron limit are typically referred to as “nanoparticles” or “nano-scale particles.” The catalytic powder is composed of non-noble transition metals including, but not limited to Ni, Co, Fe, Mn, V, Mo, Pb, and their alloys. They may be metallic, oxides or metals with oxide shells. In one embodiment, a mixture of sizes may be beneficial. Mixing 20 μm particles with 10 nm particles results in a 2000% increase in the exposed surface area of the reactive surface. The result is a great increase in the reactive surface and the catalytic behavior of that surface. Other mixtures of sizes are also possible. The reactive metal nanoparticles may be formed through any known manufacturing technique, including, for example, but without limitation, ball milling, precipitation, plasma torch synthesis, combustion flame, exploding wires, spark erosion, ion collision, laser ablation, electron beam evaporation, and vaporization-quenching techniques such as joule heating. The above are examples and not intended to be limiting of the possible methods of manufacture. The nanoparticle features and methods discussed above may be applied to all the embodiments disclosed as possible. Thus, any of the nanoparticle coatings discussed herein may be used with any of the substrate or substrate/device combinations disclosed in the present application.

FIG. 4A illustrates a 3D electrode full cell configured to generate hydrogen and oxygen from water. Electrolyte 401, such as aqueous potassium hydroxide (KOH), sodium hydroxide (NaOH), or a mixture of the two, may be placed in a first chamber 402 and 407 via inlet ports 403 and 410. When a voltage is applied between a cathode electrode 404 via electrical terminal 405 and an anode electrode 408 via terminal 409, hydrogen gas 412 is produced by 2H₂O+2e⁻→H₂+2OH⁻. The hydrogen gas rises and leaves via port 403 to be collected and/or consumed. Hydroxyl ions produced in the reaction permeate the separator membrane 406. A second chamber 407 lies adjacent to chamber 402. The hydroxyl ions have a very short distance to travel to reach the counterpart chamber 402. Oxygen is produced according to: 2OH⁻→½ O₂+H₂O+2e⁻. Oxygen gas 413 rises and leaves via port 410 to be collected and/or consumed. Water produced in the reaction permeates the separator membrane 406 driven by osmosis. The device is shown housed in a vessel 411 which may have properties as discussed above with reference to vessel 312.

The system configuration illustrated in FIG. 4A may have several characteristics that contrast with the fluidized bed reactor electrolyzer shown in FIG. 1, including:
a) no pumping is required to move gases;
b) no agglomeration occurs because the nano catalyst is firmly adhered to the electrodes;
c) the space between the two electrodes may be kept very close so that resistance losses are minimized; and
d) The full cell, which can be stacked to produce large quantities of hydrogen in a dense configuration.

FIG. 4G illustrates a forced convection electrolyzer 446 with a pressure vessel 430 defining a receiving chamber 447, a hydrogen generating chamber 448, and an oxygen generating chamber 436. A pump 440 pumps electrolyte from the oxygen-generating chamber 436 to the receiving chamber 447, thereby generating a pressure in a receiving chamber 447. The pressure in the receiving chamber 447 forces electrolyte through a three-dimensional electrode 424 pushing hydroxyl ions and hydrogen gas bubbles 444 out of the three-dimensional electrode 424 into the hydrogen generating chamber 448 where the hydrogen bubbles 444 float to an outlet 452 and through a control valve 422. The latter regulates the pressure in the hydrogen generating chamber 448. A porous separator 442 prevents bubbles from passing through a three-dimensional electrode 432 into an oxygen generating chamber 436 while permitting electrolyte enriched with hydroxyl ions to pass into the three-dimensional electrode 432. Oxygen bubbles 434 float out of the oxygen generating chamber 436 and thereout through an outlet 428 and control valve 426, which regulates the pressure in the oxygen generating chamber 436. The electrolyte, depleted of hydroxyl ions, is captured in an outlet line 438 and fed by the pump 440 back to the receiving chamber 447. A controller 456 may be used to regulate the pump 440 and/or the control valves 422 and 426. The separator 442 may be a hydrophilic porous sheet with pores sized to provide a bubble point that allows a desired pressure to be generated which allows the electrolyte to flow without permitting the hydrogen gas to pass through. Note that in the present embodiment, the positions of the hydrogen generating electrode and oxygen generating electrodes can be switched. Also, a series of electrodes with separators can be provided in a cascade of arbitrary number and length in the manner of the embodiment of FIGS. 5A and 5B, discussed below.

FIG. 4H shows a variant of the embodiment of FIG. 4G in which the hydrogen generating electrode 425 is positioned adjacent the separator 442. In this embodiment, the hydrogen bubbles 444 flow out of the hydrogen generating electrode 425 against the forced convection current. Note that the hydrogen and oxygen generating sides, or equivalently, the pumping direction, could be reversed. Also, the pump could be replaced by a gravity feed of electrolyte, such as a container which is periodically refilled so that a continuous type of pump is not required. Also, a further embodiment which is essentially both of the embodiments of FIGS. 4G and 4H, has a movable electrode that moves toward or away from the separator. In the configuration of FIG. 4H, the convection flow rate may be limited because the bubbles have to go against the gas flow, but in the configuration of FIG. 4G, they do not. Thus, under control of a controller, the configuration can be switched from that of FIG. 4H to that of FIG. 4G and the rate of pumping increased under high demand conditions and then the configuration reversed and the flow reduced under low demand conditions. Also, pumping could be stopped in the configuration of FIG. 4H and exchange governed entirely by diffusion in yet another embodiment.

FIGS. 5A and 5B illustrate the connection of multiple full cells together by manifolds for gas management and electrolyte communication between the cells, filling and level balancing. FIG. 5A shows a cross section of one embodiment of a full cell device outer body parts. The cathode half-cell 500 is housed in a plastic housing 501 such as Noryl or other thermally stable plastic that can tolerate pH of 16. The electrolyte is contained in the center of the body 502. There are two ports in each half-cell housing. One port 503 is for hydrogen gas to escape into the manifold 504 and the other 515 is for electrolyte filling and level control. The anode half-cell 506 is a mirror of the cathode half-cell and composed of a similar material. The electrolyte is contained in the center of the body 508. There are two ports in the half-cell housing. One port 509 is for hydrogen gas to escape into the manifold 510 and the other 514 is for electrolyte filling and level control. The anode 514 and cathode 515 filling tubes are separate except for a small diameter shunt tube (not shown), which will maintain anode and cathode electrolyte levels with essentially no ionic shunting.

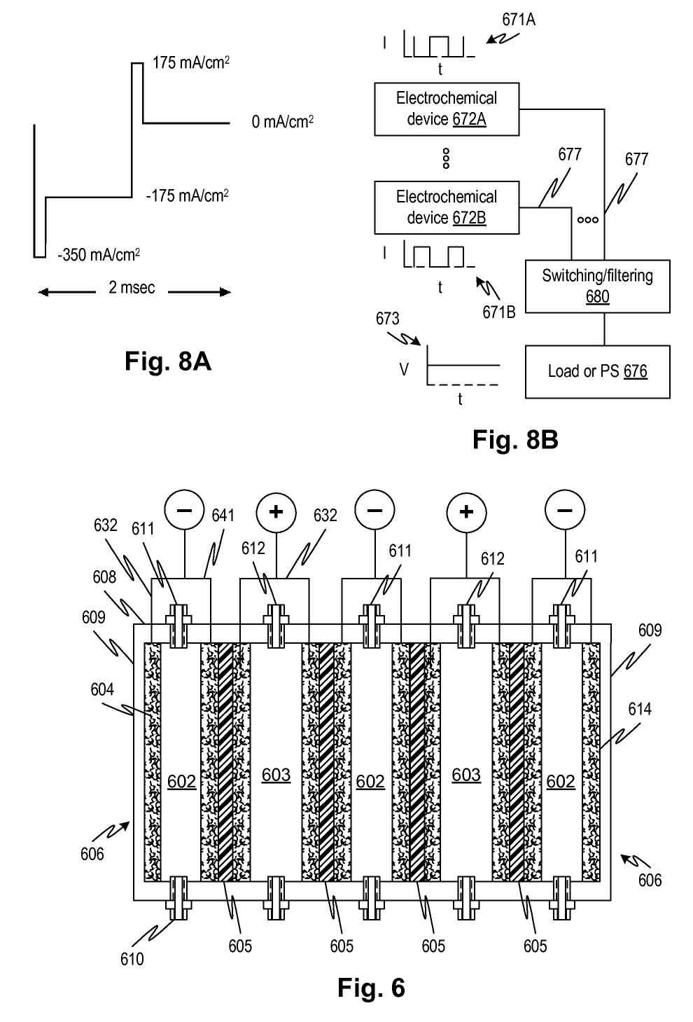

The two housings 501 and 507 may be arranged as a stack 568 as shown in FIG. 5B with an electrode pair 552 (anodic) and 556 (cathodic) between them separated by a separator sheet 554. At the ends of the stack, flat plates (not shown) may be used as terminations. The stack may be held together by bolts 560, which pass through holes 511. A voltage may be applied to the electrodes as indicated at 562 and 564. Further details of the electrode configuration are illustrated in FIG. 6, discussed below.

The module of FIGS. 5A and 5B may be combined in number in parallel-series arrays to build electrolyzers to achieve a target voltage, current, and output capability. A water make-up apparatus may be provided, for example, in the form of a vertical tube, running from either electrolyte manifold tube 405c or 405a. A level sensor may be provided to open a solenoid valve to allow water to be added to the manifold.

FIG. 6 illustrates a functional stack of cells 601. Cathodic cells 602 generate hydrogen and anodic cells 603 generate oxygen. The three-dimensional electrodes 604, 614 may be provided according to any of the structures described in the present specification, for example, they may include a reticular substrate such as foam metal coated with a nanoparticle coating. Between each cell is a separator 605, which is preferably one which can tolerate a pH 16 environment, temperatures of over 100 degrees C. and ion flux in excess of 5 amps per cm². For example, cellulose may be used as a separator. Many alternative materials are possible, for example, Zirfon® membrane made by Vito NV of Boeretang, Belgium. The body 608 may be composed of a plastic that can tolerate the high thermal stress of 100 to 140 degrees centigrade and pH 16. Any electrolyte inlet/outlet 610 may be provided for each cell 602, 603. A shunt may be provided for level re-balancing of the electrolytes. All cathode electrodes 604 are connected to a negative pole of a power supply and all anode electrodes 614 are connected to the positive pole of the same power supply. The anode 604 and cathode 614 electrodes may be coated with the same or different formulations of catalytic coatings 405. The anodic cell's 602 output hydrogen exits through an opening 611 at the top of the chamber 602, which may communicate to the hydrogen manifold described earlier. The cathodic cell's 614 output oxygen exits through an opening 612 at the top of the chamber 613, which communicates to the oxygen manifold described earlier. This embodiment may be assembled in the manner of the embodiment of FIGS. 5A and 5B.

Power to the electrodes may be controlled to maintain the electrolyte in a target range, for example, 140 C and preferably below 100 degrees centigrade through a negative feedback. This may be accomplished through temperature feedback control of a pulse-width modulated voltage applied to the electrodes or other suitable means. A cooling device may be employed, such as a heat exchanger, to maintain temperature. The power may be provided in a waveform as discussed elsewhere herein. For example, the co-plating waveform discussed with reference to FIG. 8 has a brief reverse pulse may be used. Brief high current pulses may also be used. These waveforms are examples, only, and are not required. With any waveform, the root-mean-square (RMS) current can be varied by altering a duty cycle.

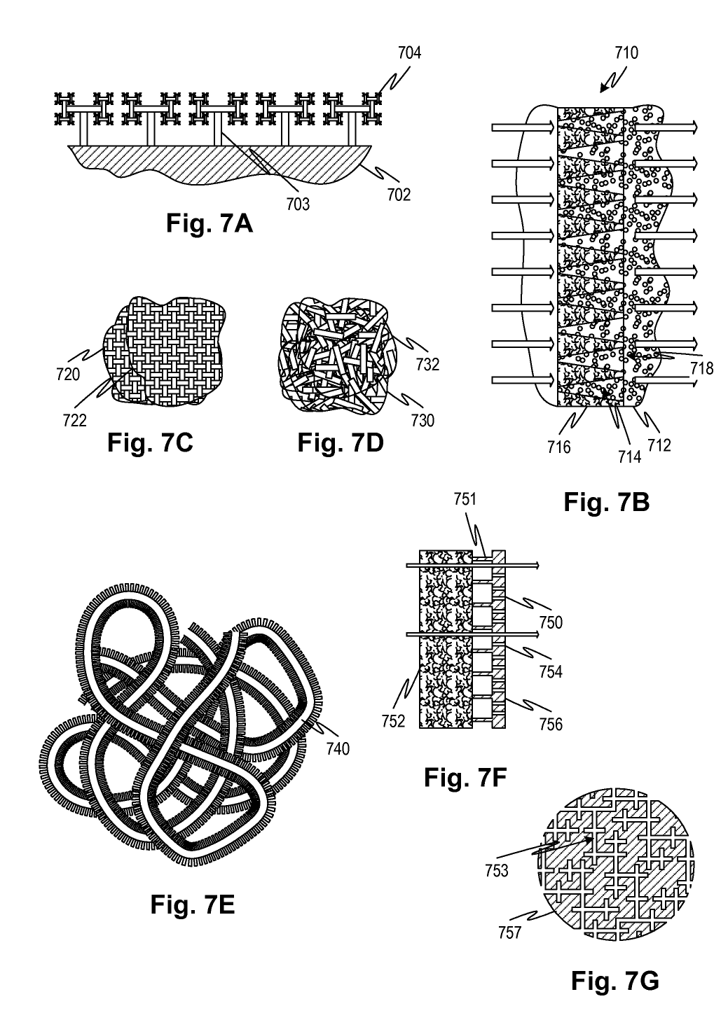

Referring to FIG. 7A, a substrate for the three-dimensional electrode may take many forms. FIG. 7A shows a substrate 702 with dendritic extensions 703, 704 having a self-similar type of symmetry. FIG. 7B shows an electrode 710 having substrate 716 with recesses 714 that are progressively larger forming outlets 718 in a face thereof. The outlets 718 allow gas to escape. The recesses are narrower toward a blind (but porous) end and wider toward the face so that as more gas enters the recess and moves away from the blind end, the area for gas movement increases. FIG. 7C illustrates another embodiment of a substrate having multiple sheets of a woven metal textile, 720 and 722, for example, that are laid on top of one another. These may be riveted or cross-bonded together or otherwise interconnected for current conduction. FIG. 7D illustrates multiple layers 732, 730 of a non-woven textile, such as randomly arrayed metal fibers that are sintered, welded, or electroplated together. FIG. 7E illustrates wire 740 with fins which may be compressed into a structure like a pad of steel wool. FIG. 7G illustrates, in cross-section, a single flow channel 753 with multiple folds in it so that it presents a high surface area to an electrolyte fluid, or components thereof (e.g., bubbles, water, ions), flowing therethrough. The section is taken across the direction of flow which may be driven by forced convection, buoyancy, or diffusion. FIG. 7G shows that a high surface flow-through configuration for a substrate need not contain many, or even multiple, channels.

All of the structures of FIGS. 7A-7E and 7G may provide one or more portions of a substrate suitable for making a three-dimensional electrode. In each case, the substrate is preferably coated with nanoparticles, such as by coplating.

FIG. 7F illustrates a current collector 750 that forms a separate structure or portion of the electrode to carry current. Contact elements 751 make contact at multiple points of the electrode 752 and convey the current to a conducting channel 756. The latter may have openings 754 to permit a flow of ions, water, or gas, depending on the application (fuel cell, electrolyzer, etc.). The contact elements 751 and conducting channel 756 form a scaffold that may also help to provide structural support for the electrode 752. The electrode 752 may be of any of the structures discussed herein. The electrode structure may include its own internal scaffold. For example, a reticular foam may be attached to a thick screen to carry current. The scaffold or scaffold/current collector preferably contacts the electrode at multiple points to eliminate current bottlenecks within portions of the electrode material that are unable to channel high current loads.

Attachment of the nano and micron scale particles may be accomplished by any of a variety of processes including sputtering, thermal treatment of silver-containing metals or coplating among others. The catalytic nano and micron powders used in this embodiment include many transition metals from groups 3-16 and more specifically; are composed of nickel, iron, manganese, cobalt, tin, gold and silver, or combinations, alloys, and oxides thereof. The substrate may also include transition metals and is more preferably iron, steel, stainless steel, nickel, silver and alloys of these metals. Carbon would may also be suitable on the cathode (hydrogen generating) half of the cell. The substrate and the catalysts do not need to be the same or even similar. Where coplating is used to attach the particles, the electroplating metal should be stable in alkaline environments, for example, it may be, or include, nickel, tin, gold, silver. Examples of nanoparticle materials for alkaline electrolyte for the cathode include nickel, stainless steel, or iron for the cathode. For the anode, examples of nanoparticles include nickel, stainless steel, or tin. As in all the embodiments, the selected metal selected to be stable in the electrolyte may be plated on another material as well as for the material of the electrode.

The following is an example of a coplating of a flat plate. A nickel plate was electro-cleaned using 25% NaOH electrolyte heated to 65° C. and driven cathodically at about 0.1 Amps/cm² for about one (1) minute. The plate was rinsed in distilled water and dipped into neutralizing acid bath composed of Sodium Bifluoride acid at room temperature for about a minute. A room temperature plating bath was prepared composed of about 30% nickel chloride (NiClsub2) and 3% boric acid to achieve a pH of about 1.0. The bath can be purchased pre-mixed from Rio Grande #335-086 and is known as a “Wood's Strike.” Alternatively, hydrochloric acid can be used to reach the same pH. A nickel anode was used and current applied at about 25 mA/cm squared for three (3) minutes. The plating forces a thin coating of nickel resulting in a pristine surface for further coatings. The current may be pulsed to about 50 mA/cm squared at a 50% duty cycle for three (3) minutes. A short negative pulse may also be used in the plating program. A DC current may also be used.

A “Bright Nickel” plating bath was prepared composing of about 30% Nickel Sulfate, about 4.5% Nickel Chloride, about 3.5% Boric Acid and may include a small amount of Sodium Saccharin. This bath can be purchased pre-mixed from Rio Grande #335-078. This bath is held at about 65° C. A solution of 10% sulfuric acid is used to maintain a pH of about 4 to 5.

Catalyst powders were added to the plating bath at a loading of about 1% of the total bath weight. Preferably, the catalyst is above 0.5% of the bath weight. For the present example of a cathodic electrolysis electrode, nano iron, nickel and cobalt in equal measure to about 1% of the electrolyte weight (about 0.33% of each catalyst) was used. Catalysts could be, or include transition metals, including not limited to nickel, iron, tin, silver, manganese, cobalt and their alloys and oxides. Any agglomeration in the dry powder may be broken up with a mortar and pestle or other suitable, e.g., milling, process prior to addition to the plating bath. Alternatively, the nano particles may be mixed with enough bath liquids to fully suspend them (˜25 w/w) followed by ultrasonic agitation. The mixture was then added to the plating bath resulting in a 1% w/w final combined loading. The mixture was agitated using a small high-sheer blender.

The plating bath containing the particles was heated to 65 degrees Celsius and agitated using a small hand-held mixer. Air agitation may also be used for bath circulation. The cleaned and “Wood's Strike” plated conductive surface was then positioned at the bottom of the plating bath container. As much as a minute of settling time was permitted before initial plating. A nickel counter electrode was positioned at the bath surface above the electrode and spaced from the electrode to be plated. An ultrasonic transducer may be attached to the plating bath or to the nickel counter electrode for periodic bath agitation. This agitation occurred every five minutes during the hour of plating time with zero to 30 seconds allowed for settling of the nano powders over the surface of the electrode plate.

A plating power supply was connected to the electrodes with the negative connected to the conductive panel intended to be coated and the positive to the anode counter electrode composed of essentially pure nickel. The wave shape during coplating was rectangular, although other waveforms may be used, including pure DC. A frequency of about 500 Hz was used, though good results have been achieved using waveforms with frequencies from DC to 10000 hertz. A duty cycle of about −175 mA/cm2 with a maximum peak of about −350 mA/cm2 was used. This was followed by a short 175 mA/cm2 followed by resting at 0 mA/cm2 for the remainder of the cycle. The overall duty cycle averaged −90 mA/cm2 with a duty cycle of 50% and lasted for five minutes. FIG. 8A is an example of this reverse pulse wave-shape.

While the current was off, following the above plating interval, the plating bath was agitated. Again, up to a minute was allowed for settling of the powders onto the electrode surface before current was applied as before. The sequence was repeated up to 10 times for flat plates. Vigorous rinsing follows the last step to remove any loosely adhered particles.

In an alternative plating method, the current is left on continuously with periodic re-agitation of the bath at about 5 minute intervals until the desired loading of powders is reach. A total of 30 minutes of coating time may be applied with five agitation steps.

The above procedure, for example five coplatings of 6 minutes each with solution agitation between applications may be performed for each side. The sample may then be inverted and five more coplatings performed. The total number of cycles may be as high as 50, resulting in 50 coatings. In example embodiments, 5 per side were used. In an embodiment, a circulating plating bath may be used which stops circulation when current is applied with an interval between applications of the current. In another embodiment, the current pulses remain on continuously with the periodic application of agitation, for example, every five minutes. In any of the embodiments, after coplating application is applied, a vigorous rinsing step may be employed to wash off poorly adhered particles.

The process above may be used for the fabrication of anodic electrode. For example, a suspension of equal weights of iron, cobalt and tin nano particles in equal weight measures totaling greater than 0.5% of the liquid weight may be used.

Referring to FIG. 8B, one or more electrochemical devices 672, for example, electrolyzers, can be intermittently connected to a power source or sink 676 through a switching/filtering system 680 to time vary the charge or discharge profile of the one or more electrochemical devices 672A through 672B. The graphs 671A and 671B figuratively indicate a charge or discharge profile which may be fractions of a hertz up to hundreds or thousands of hertz. The voltage of graph 671A and 671B may indicate negative or positive current flow versus time, depending upon whether the electrochemical devices 672 are consumers of power or suppliers of power. The electrochemical devices 672A and 672B may be according to any of the electrochemical device embodiments disclosed or any other electrochemical devices which consume or generate power. The switching/filtering device 680 may be configured to switch the load or power supply 676 to one or more of the electrochemical devices 672A and 672B, through a network of electrical leads 677, such that the load or power supply 676 “sees” a constant drain or source of power 673. In the case of a power supply (676), the power supply may be configured such that its output is pulsatile and a separate switching/filtering device 680 may be unnecessary.

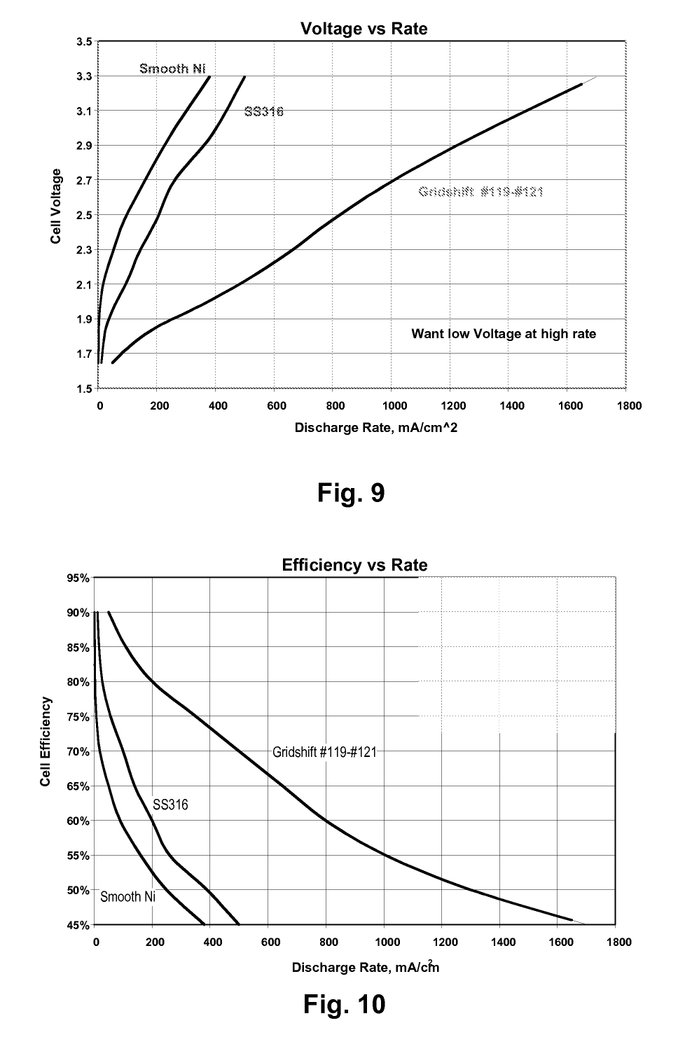

FIG. 9 is a graph showing the results of tests of an electrode comparing smooth nickel (“Smooth Ni”) and stainless steel (“SS316”) with an electrode coated according to the above example (“Gridshift #119-#121”). The graph shows cell voltage versus discharge rate. The lower the voltage for a given current indicates a desirable characteristic for reasons that should be clear from the present application's discussion as well as others. Energy Efficiency may be calculated by dividing 1.482 by the cell voltage. Note that area is normalized to 1 centimeter squared. In this set of data, the actual surface area was also 1 centimeter squared.

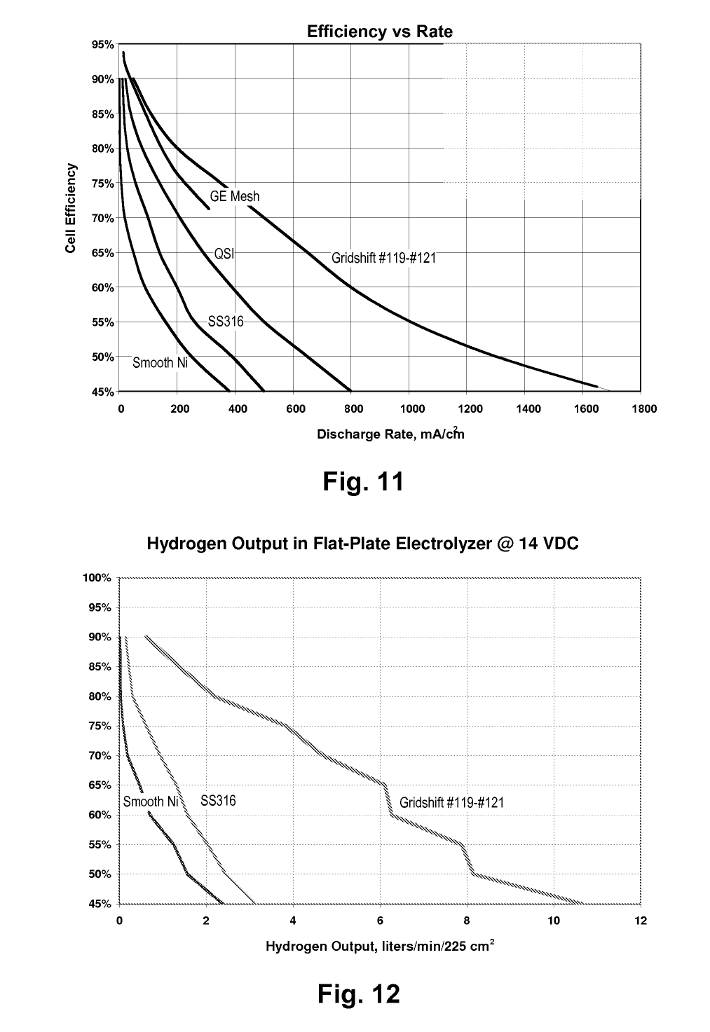

FIG. 10 shows the same set of three comparisons as FIG. 9, but with energy efficiency as the dependant axis. High efficiency at high rates is desirable. FIG. 11 compares test results of other types of electrodes made by QSI and GE. The QSI data is derived from unpublished experiments and the GE was derived from a paper given at the National Hydrogen Association meeting in 2008. These are the only electrode data available to this laboratory for comparison. FIG. 12 compares the calculated hydrogen output from a water electrolyzer using various plates. It assumes an overall voltage of 14 volts and plate size of 225 cm2 (˜6 inches square). The jaggedness of the line is due to changes in the number of series cells that can be inserted as the cell voltage decreases (Energy Efficiency increases) allowing for more hydrogen to be produced by any one amount of current.

In tabular form, the same data is provided in Table 1 below. It is clear that the gas output using the coating process described in Example 1 is far superior to the typical SS316 plates, and much better than the two known comparison products.

TABLE 1

| | mAmps/ | H₂ out @ 75% | Compared |
|---|---|---|---|
| | cm² at | with 14 VDC & | to Exam- |
| Electrode Type | 75% Eff | 225 cm² plates | ple 1 |
| Flat Nickel | 8 | 0.088 | 2% |
| Flat Stainless Steel 316 | 57 | 0.620 | 16% |
| Competitor 1 (QSI) measured | 140 | 0.153 | 40% |
| Data | | | |
| Competitor 2 (GE) from paper | 230 | 2.52 | 66% |
| Example 1: #119/#121 | 350 | 3.84 | 100% |

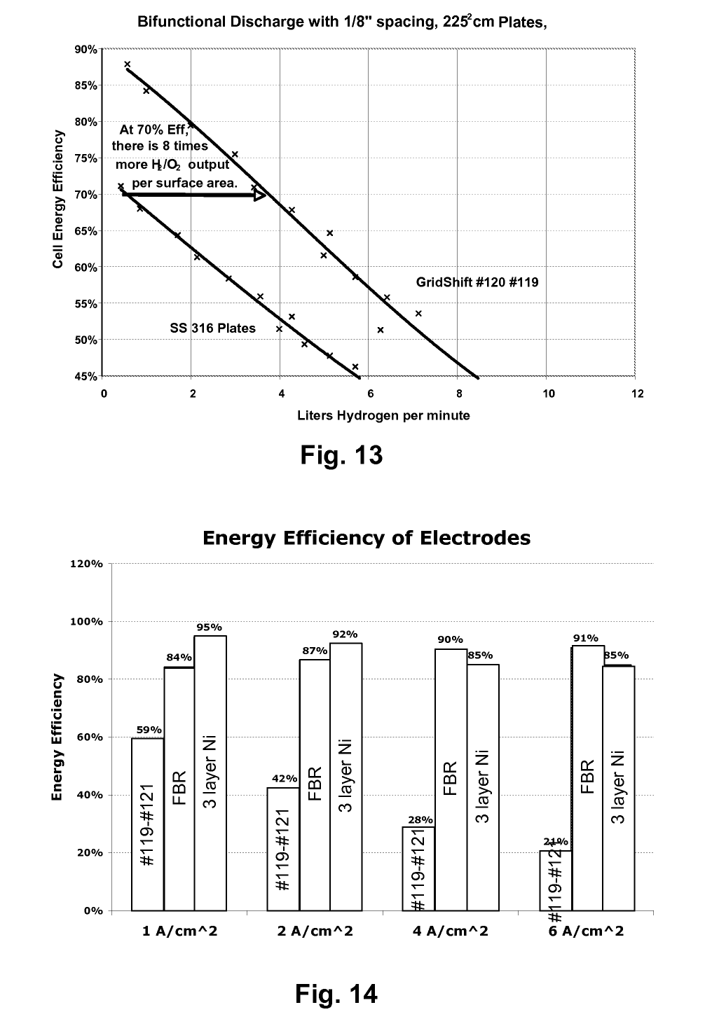

The coated flat plate can be assembled into a bipolar electrolyzer to produce both hydrogen and oxygen. With no separator, the output gasses are mixed in a ratio of two moles of hydrogen per mole of oxygen. FIG. 13 shows the resulting hydrogen output from such a cell. These data were extrapolated to a 225 cm² surface area plate (˜6 square inches) and ⅛ inch spacing of the plates. The output is over 8 times greater when using the coated plates described in Example 1. Also, the output resulting from half-cell data in FIG. 12 is similar to the measured data from a whole cell in FIG. 13. The application could be used to provide “on demand” hydrogen for an internal combustion engine for efficiency improvement.

Electrolyzers are generally built from flat plat electrodes. Some are called “bipolar” in which a single plate functions as a cathode on one side producing hydrogen and functions as an anode on the reverse side producing oxygen. Electrons pass through the solid electrode plate. Between the plates ions pass through the electrolyte, competing with the outpouring gasses for reaction surface area on the electrode. In an electrode according to the embodiment of FIG. 4A, ions move toward the opposite pole, while the gasses move in an independent direction, for example, an opposite direction, driven at least in part by buoyancy forces.

In the present example, a cathodic 3-Dimensional (3D) electrode accepts electrons and produces hydrogen gas 412 that escapes in one direction while the hydroxyl ions will migrate through a separator in an opposite direction toward an electrode of opposite polarity. The ions pass through a separator 406, which is electrically insulating but allows free passage of ions.

There are many possible candidates for the separator 406 including microporous sheets or composite materials such as the commercially available alkaline battery separator materials such as Acropore or Celguard, which are micro-porous. Some newer products are also on the market including a product named “Zirfon” membrane made by Vito NV of Boeretang, Belgium. Another separator would be non-porous material similar to that used in Silver-Zinc alkaline batteries, which are modified cellulose (Cellophane). Experimental grafted polysulfone separators being made by Sandia National Laboratories are non-porous and work well.

Anode and cathode 3D electrodes are used on either side of the separator, producing oxygen 413 on one side and hydrogen 412 on the other. Hydroxyl and water are exchanged across the membrane and they move away from the respective electrodes in respective directions that are opposite the flow of gases. This leads to efficiency advantages at high gas-generation rates because the ions and water do not compete for the electrode “real estate” with the gases, since they move away from each other.

FIG. 4B shows first and second electrodes 470 and 471, which have corrugated surfaces 470A and 471A that face each other. A corrugated separator 472 follows the corrugated surfaces 470A and 471A. The structure of FIG. 4B can be obtained by forming a separator on the corrugated face of one or both of the electrodes and pressing them together so that the ridges of one electrode fit within the troughs of the other, putting the separator between them. Alternatively, a separator sheet, forming the separator 472, can be squeezed between the corrugated surfaces.

FIG. 4C illustrates a separator 476 with cathode 474 and anode 475 electrodes attached to it. As indicated in FIGS. 4D and 4E, the separator can be folded to produce an electrode pair 480 with a high surface area of separator per unit face area. Also, the folding may provide channels 479 for the escape of gases. In addition to one-dimensional folding, electrode separators may be folded based on two-dimensional patterns, for example, meshing dimples or egg-create patterns. Note that the electrodes may be inserted snugly in a gap between facing surfaces 490 of a cell with conductive strips 482 and 484 providing external contact to the electrodes for carrying current. The conductive strips 482 and 484 may be lead out between the sealed cells 501 and 507 in a stack 568 arrangement as described with reference to FIG. 5B. Referring to FIG. 4F, another embodiment of a separator with enhanced area per unit of face area is a corrugated separator 466 provided between non-meshing electrodes 462 and 464 on either side thereof.

A series of thickness and density experiments were run in a half-cell apparatus seeking the best performance at several high current densities. This data was compared to both the best flat-plate performance in Exhibit 1 and also compared to an electrochemical fluidized bed reactor such as that described in U.S. patent application Ser. No. 12/045,625 to Dopp. FIG. 14 is a bar graph showing the comparison of the best performing 3D electrode with no added catalysts. It is composed of INCO foamed nickel with 1450 g/m2 density and 4.5 mm thick and a pore size of about 600 um diameter. This material is reticulate foam with interconnected pores and a very high pore volume. Alternatively, foam stainless steel or even steel would work well as a current collector. Most any transition metal would work as the base current collector if coating plating was accomplished effectively with few pores remaining exposing the base metal. The preferable material is Stainless steel, nickel or related alloys.

This example demonstrates that the primary advantage of the fluidized bed reactor (FBR) was the ability to separate the competing ions and gasses. However, the FBR has several disadvantages, including the agglomeration of particles, which eventually causes the particles to stop functioning as a fluidized bed. This causes a loss of the increased performance. The FBR has a more serious problem and that the separation of movement is dependant on gravitationally driven buoyancy of the gasses. This works fine in a half-cell oriented horizontally (as illustrated in FIG. 1) but is impractical in a full cell. If the two electrodes are situated side-by-side, then a very large ionic bridge is required. If situated vertically, the particles needed for fluidization fall to the bottom of the chamber requiring constant agitation of the electrolyte. At 1 amp/cm2, the foam nickel surpassed the FBR. Only at higher currents did it fail to outperform the FBR.

Another example is identical to the previous one in which the coating process described above was applied. The coating was formed on foamed nickel using a pulsed current as described above. The process was repeated 10 times on one side and ten more on the reverse side of the porous substrate. There are many wave-shapes that were tested and many function well, each with benefits and disadvantages. This shape is the best at the date of this writing.

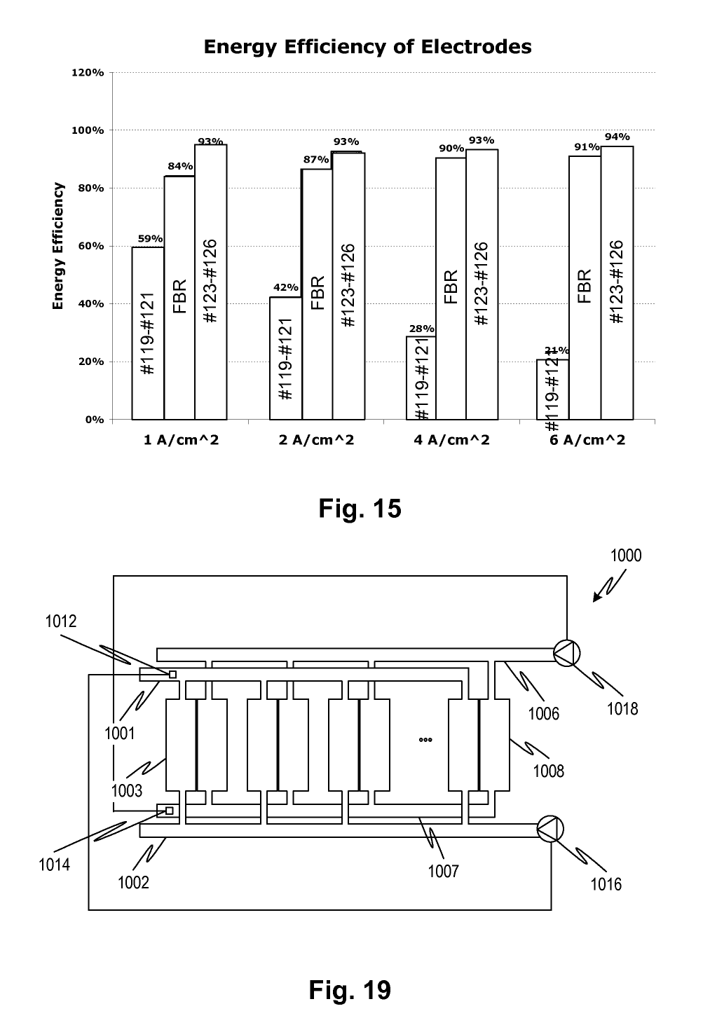

The resulting electrode was effective as evidenced in FIG. 15. Note that even at high rates, the 3D design using coated surfaces is superior to the FBR. Table 2 presents this data in tabular form. The remarkable and unexpected high performance of the coated 3D electrode is clearly evident in these data.

TABLE 2
Energy Efficiency on high rate electrolysis

| | Example 1 | | | Example 3 |
|---|---|---|---|---|
| Current | Coated Flat | Comparison | Example 2 | 3D with |
| Density | Plates | FBR | 3D Ni Foam | Coating |
| 1 A/cm² | 59% | 84% | 95% | 93% |
| 2 A/cm² | 42% | 87% | 92% | 93% |
| 4 A/cm² | 28% | 90% | 85% | 93% |
| 6 A/cm² | 21% | 91% | 85% | 94% |

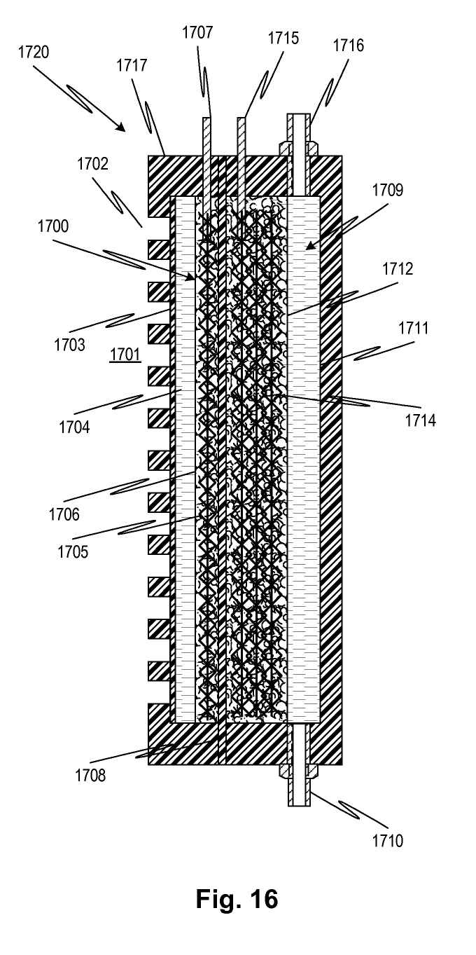

Referring to FIG. 16, a schematic of a fuel cell embodiment with 2D oxygen reducing electrode 1701 and a 3D fuel oxidizing electrode combination design 1720 is shown where a gas diffusion cathodic electrode 1700 functions as an oxygen reduction half-cell electrode. Oxygen from the air or other gas source 1701 passes through openings 1702 in the fuel cell body 1717. The openings can be arrayed in any manner, and may include holes of any shape, or slots, or a screen or any other device for supporting the materials within the cell while permitting ingress of gas.

Oxygen entering through the openings 1702 encounters a porous diffuser 1703, which distributes oxygen laterally across an entire surface of a gas diffusion electrode 1706. A hard diffuser plate, such as one made of a porous ceramic, may be used to take the place of a portion of the fuel cell body 1717 and the diffuser, thereby eliminating the separate structure of diffuser and a portion of the cell body 1717 with openings 1702.

A positive electrode 1700 has a hydrophobic film 1704 to permits oxygen to move into contact with a gas diffusion electrode portion 1706 while preventing the loss of liquid electrolyte. The positive electrode 1700 also has a current collector 1705, which supplies electrons for the half-reaction H2O+½O2+2e−→2OH−. The current collector 1705 is attached to an electrochemically active layer of the gas diffusion electrode portion 1706 and is in electrical contact with an external positive terminal 1707. In operation, hydroxyl ions diffuse through a separator 1708 which is permeable to hydroxyls and water but with very small or no pores such as Celguard 5550® or cellophane. Adhesion of this layer to the positive electrode 1700 may be accomplished using a polyvinyl alcohol (PVA) and carboxymethylcellulose (CMC) mixture for example.

Note that the drawing of FIG. 16 is intended to illustrate basic structural features and the sizes of elements are exaggerated to make their arrangement clear. Thus, the drawing should not be understood to show the relative sizes or thicknesses of elements in a working embodiment.

A non-fluidized bed three-dimensional (3D) electrode component 1709 is in close contact or adhered to the separator 1708. An alkaline anolyte 1709 composed of a KOH or NaOH (or mixture of the two) aqueous solution contained in an anode chamber 1711 contains small hydrogen bubbles dispersed throughout. The anolyte 1709 mixture is pumped through port 1710 into the anode chamber 1711. The hydrogen contacts the reactive surface of a negative electrode 1712, which is an open-pored structure such as a reticular foam 1713. In an embodiment, the open-pored structure is coated with catalyst powders of micron or nano size. The preferred minimum size of the catalyst powder is less than 50 nm.

The anolyte 1709 flows into the foam where the electron liberating reaction H2+2OH−→2H2O+2e− occurs. Electrons are collected on a current collector 1714 in the electrode and eventually exit the cell on the negative terminal 1715 in contact with the current collector 1714. The anolyte 1709 is continuously circulated, exiting the cell via port 1716. Additional hydrogen gas is supplied at some external site.

The body of the device 1717 may be of any non-conductive material capable of withstanding a pH over about 12 such as ceramic, acrylic, PVC, nylon or Noryl among others. Assembly is accomplished by any means that compresses the components together.

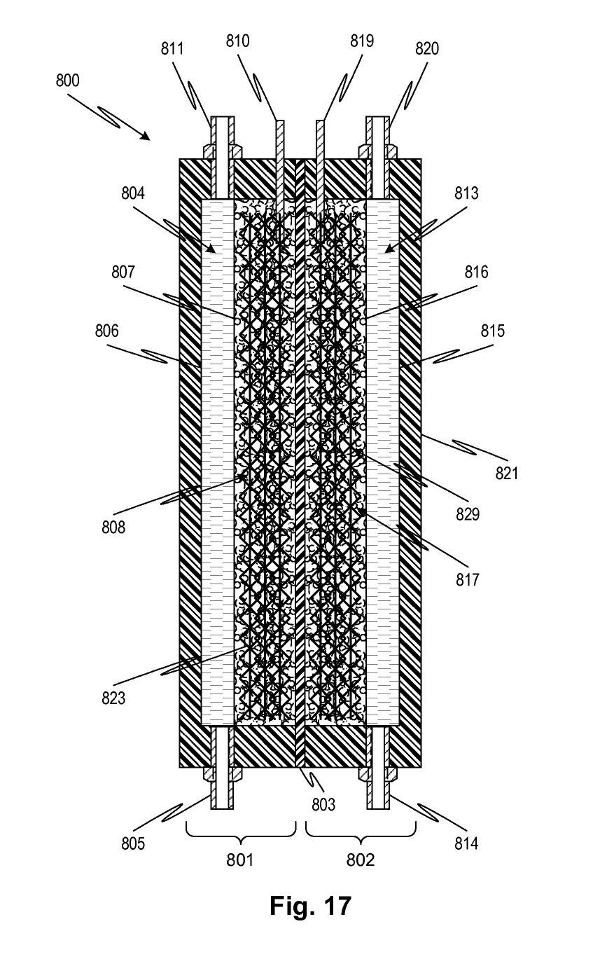

FIG. 17 illustrates a dual 3D electrode pair 800. Two electrode half-cells (cathode half cell) 1702 and (anode half cell) 802 are separated by a separator 803. The cathode half cell 801 is has an electrode component 807, which in close contact or adhered to the separator 803. The separator 803 is permeable to hydroxyls and water but with very small or no pores such as Celguard 5550® or cellophane. Adhesion of the separator 803 to the electrode component 807 may be accomplished using a polyvinyl alcohol (PVA) and carboxymethylcellulose (CMC) mixture for example. An alkaline catholyte 804 composed of a KOH or NaOH (or mixture of the two) aqueous solution with small oxygen bubbles dispersed within this catholyte 804. This mixture is pumped through port 805 into a cathode chamber 806. The oxygen in the catholyte 804 contacts a reactive surface 807 of the electrode component 807, which includes an open-pored structure 808, for example a reticular foam. This open-pored structure 808 may be coated with catalyst powders of the micron or nano size. The preferred size of this catalyst powder is less than 50 nm.

The electrolyte containing catholyte 804 permeates the open-pored structure 808 where the electron consuming reaction occurs. Electrons supplied from a positive terminal 810 are donated from a current collector 823 in contact with the open-pored structure 808. The catholyte 804 is continuously circulated by flowing from the inlet port 805 to an outlet port 811. Additional oxygen gas is supplied to the catholyte 804 by a suitable process.

The anode half cell 802 is has an electrode component 816 in close contact or adhered to the separator 803. Adhesion of the separator 803 to the electrode component 816 may be accomplished using a polyvinyl alcohol (PVA) and carboxymethylcellulose (CMC) mixture for example. An alkaline anolyte 813 composed of a KOH or NaOH (or mixture of the two) aqueous solution with small hydrogen bubbles dispersed within this anolyte 813. This mixture is pumped through port 814 into an anode chamber 815. The hydrogen in the anolyte 813 contacts a reactive surface of the electrode component 816, which includes an open-pored structure 829, for example a reticular foam. This open-pored structure 829 may be coated with catalyst powders of the micron or nano size to form the reactive surface. The preferred size of this catalyst powder is less than 50 nm.

The electrolyte containing anolyte 813 permeates the open-pored structure 829 where the electron liberating reaction occurs. Electrons collected by a current collector 823 in contact with the open-pored structure 808 are applied to negative terminal 819. The anolyte 813 is continuously circulated by flowing from the inlet port 814 to an outlet port 820. Additional hydrogen gas is supplied to the catholyte 804 by a suitable process.

The body of the device 821 is any non-conductive material capable of withstanding a pH over about 12 such as ceramic, acrylic, PVC, nylon or Noryl among others. Assembly is accomplished by any means that compresses the components together.

The cells 800 can be arranged in series or parallel networks as the desired voltage and current requirements. Series connection of the cells results in the same current capability but linear voltage increase (two cell gives twice the voltage) and parallel connecting gives the same voltage, but linear current increases (two cells gives twice the current).

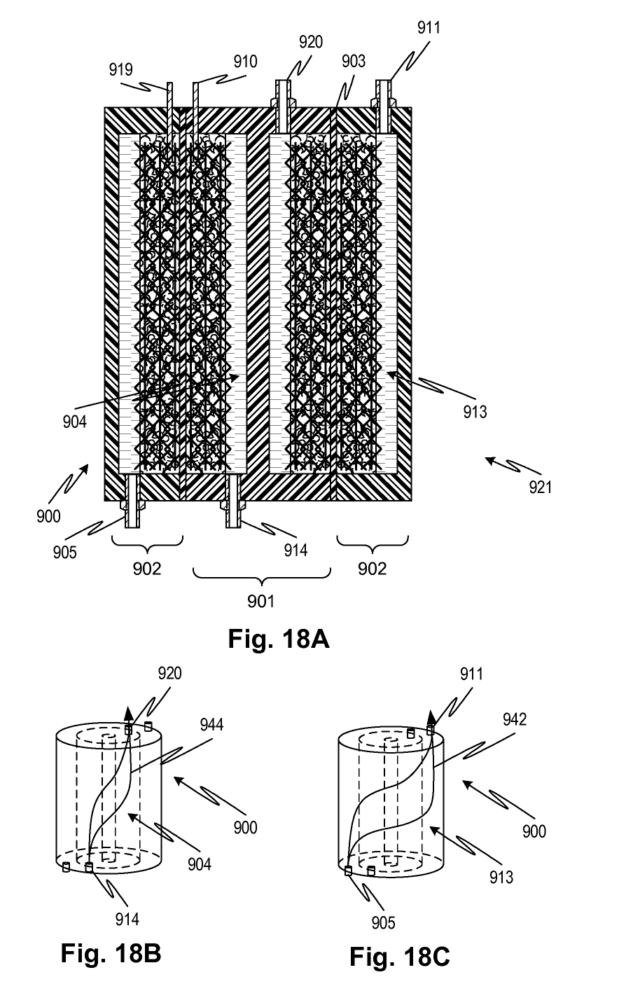

FIG. 18A shows a cylindrical fuel cell 900 which is essentially a cylindrical development of the cell 900 described with reference to FIG. 17. In other words, there are two cylindrical half-cells 901 and 902 which are arranged one inside the other with a cross-section on one side that is essentially the same as the one shown in FIG. 17. Referring also to FIG. 18B, a catholyte is supplied to an inlet port 914 and exits through an outlet port 920, thereby causing it to circulate throughout a cathode chamber 904. Referring also to FIG. 18C, an anolyte is supplied to an inlet port 905 and exits through an outlet port 911, thereby causing it to circulate throughout an anode chamber 913. The other features of the structure of the two half-cells 901 and 902 being as described with reference to FIG. 17, catholyte and anolyte chambers 904 and 913, respectively, contain the electrode structures, a separator, current collector, and other elements such that terminals 910 and 919 are energized.

FIG. 19 shows multiple cells joined by manifolds that distribute catholyte and anolyte to the multiple cells. Header 1001 supplies anodic fuel to anode half-cells 1003 and spent fuel is collected through header 1002. Header 1006 supplies cathodic oxidizer to cathode half-cells 1008 and spent oxidizer carrier is collected through header 1007. Sensors 1012 and 1014 may detect fuel and oxygen content of the spent materials and control respective pumps 1016 and 1018 to regulate the flow of each to maintain optimal operating conditions.

An aspect of at least some of the embodiments in the disclosed subject matter to take advantage of the fact that the reticulate or porous electrode's surface area is enhanced by nano sized catalytic particles on the surface of the metal current collector and in contact with the gas-containing electrolyte. The electrolyte serves as both an ionic conductor and medium for the gaseous fuel. Preferably, the adhered catalytic particles are less than one micron in effective diameter, and most preferably less than 100 nanometers in diameter. Most preferably, the reactive metal particles are less than 50 nm in diameter such that substantial portion can infuse into the electrode. Attachment of these particles can be achieved through any one of a number of techniques but more preferable through a co-plating process with other metals. An example would be nickel plating used to capture suspended nano catalyst which then are permanently adhered to the current collecting metallic surface while still exposed to the electrolyte.

The reactive metal particles can be formed through any known manufacturing technique, including, for example, but without limitation, ball milling, precipitation, plasma torch synthesis, combustion flame, exploding wires, spark erosion, ion collision, laser ablation, electron beam evaporation, and vaporization-quenching techniques such as joule heating. The metal or metals of these nano catalysts are selected from the group consisting of non-noble transition metals including but not limited to nickel, iron, manganese, cobalt, tin, silver, tungsten, or combinations, alloys, and oxides thereof including, WC-12% Co and CoWO₄. The powders may be mixed in many specific recipes.

Additionally, reactive surface area is increased by order of magnitude by operation with catalytic nanoparticles on the surface of the electrodes. In addition to the surface area of the porous or reticulate electrode, the particles adhered to that surface give an additional surface area of the electrode. The increased catalytic behavior of the reactive metal nanoparticles, compared to the surface of the metal substrate alone, is high due to the very large number of atoms on the surface of the nanoparticles. By way of demonstration, consider a 3-nanometer nickel particle as a tiny sphere. Such a sphere would have 984 atoms on its surface and 530 within its interior, of the 914 atoms in total. This means that 58% of the nanoparticles would have the energy of the bulk material and 42% would have higher energy due to the absence of neighboring atoms. Nickel atoms in the bulk material have about 12 nearest neighbors while those on the surface have nine or fewer. A 3-micron sphere of nickel would have 455 million atoms on the surface of the sphere, 913 billion in the low energy and isolated interior of the sphere for a total of nearly one trillion atoms. That means that only 0.05% of the atoms are on the surface of the 3 micron-sized material compared to the 42% of the atoms at the surface of the 3-nanometer nickel particles.

The chemical kinetics of catalysts generally depends on the reaction of surface atoms. Having more surface atoms available will increase the rate of many chemical reactions such as combustion, electrochemical oxidation and reduction reactions, and adsorption. Extremely short electron diffusion paths, (for example, 6 atoms from the particle center to the edge in 3 nanometer particles) allow for fast transport of electrons through and into the particles for other processes. These properties give nanoparticles unique characteristics that are unlike those of corresponding conventional (micron and larger) materials. The high percentage of surface atoms enhances galvanic events such as the splitting of hydrogen or methanol to generate electrons, or the oxygen reduction reaction.

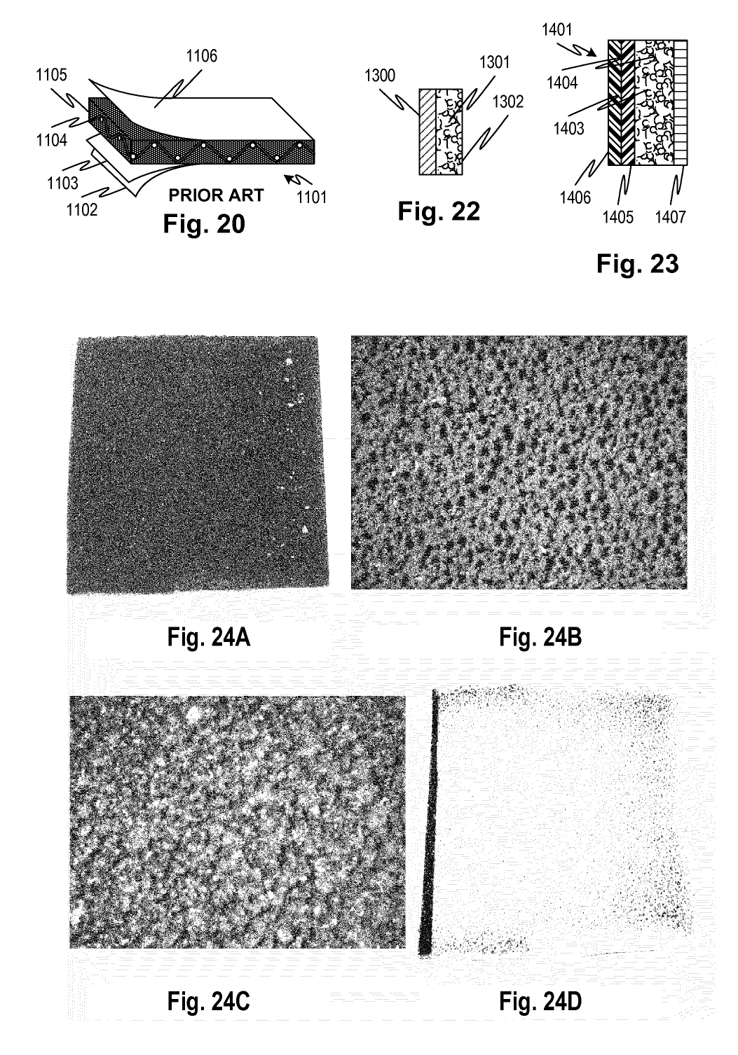

FIG. 20 illustrates a carbon-based gas electrode 101 according to the prior art. The air enters the electrode through a porous, unsintered PTFE (Teflon®) film 1102, which is primarily a gasket to prevent leakage of electrolyte. Next is another PTFE porous film (Teflon®) 1103, which is laminated to the active layer 1104. A thin layer of Teflon® emulsion such as T30b is sprayed onto the active layer 1104 prior to lamination. This active layer is composed of electrically conductive, catalyst containing matrix bonded by Teflon® particles which fibrillate during the compression step. An example composition is shown in the Table 3:

TABLE 3

| Component | Weight % | Typical % |
|---|---|---|
| Activated Carbon | Balance | 75% |
| Catalyst Powders | 2% to | 5% |
| | 15% | |
| Teflon emulsion | 5% to | 20% |
| binder | 50% | |

This active layer is roller-milled into the nickel current collector 1105. Some use nickel-electroplated steel or metallic silver. There is sometimes a coating applied to the current collector to improve carbon to current collector conductivity. Some builders use an etching process either from physical abrasion (e.g. sand-blasting) or by chemically etching the surface with a strong acid. The cathode unit is isolated form the metallic anode by some ionically conductive separator 1106. The anode can be any metal that is stable in strong alkaline environments and has a potential that is well below that of oxygen. Anode material examples are zinc, aluminum and magnesium.

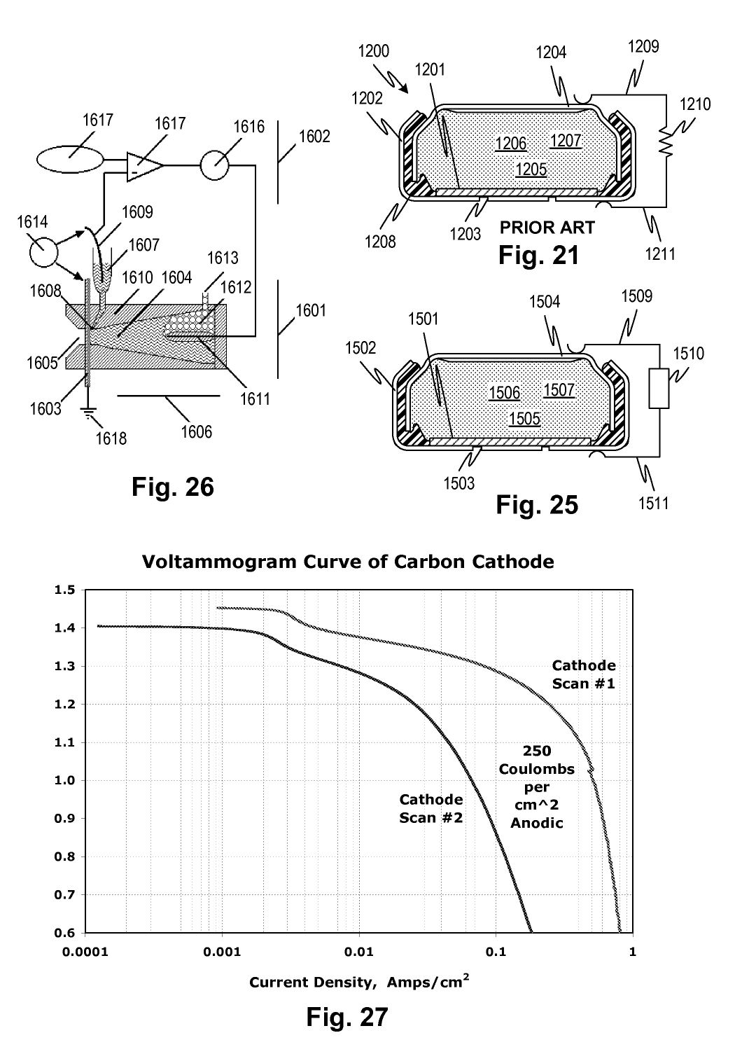

FIG. 21 illustrates a Zinc Air cell 1200. A cathode 1201 may be as described in FIG. 20 and situated at the bottom of a cathode can 1202 which has air access holes 1203 sized to allow enough air into the cell to facilitate the intended function of the cell. The can 1202 is composed of nickel; nickel-electroplated steel or nickel-electroplated stainless steel. The anode cap 1204 is composed of several layers, usually nickel on the outside, stainless steel on the inner layer and copper being exposed to the metallic anode fuel 1205. The inner surface of the cap can be copper, brass, bronze or tin. The anode 1206 contains a strongly alkaline electrolyte 1207 such as about 33% potassium hydroxide, sodium hydroxide or a mixture of the two. The anode fuel 1205 is a reduced metal such as zinc, aluminum or magnesium. The anode cap 1204 and cathode can 1202 are separated from each other with a plastic grommet 1208. This grommet 1208 may be of composed of Nylon 66 or polysulfone and may be coated with a sealant. Within the cathode 1201, oxygen is reduced by oxidizing water and releasing hydroxyls into the electrolyte by the reaction H₂O+½O₂+2e⁻→2OH⁻. The anode fuel uses these hydroxyls to oxidize the reduced metal. In the case of zinc, the reaction is Zn+2OH⁻→ZnO+H₂O+2e⁻. The liberated electrons collect on the anode cap making it negatively charged. These electrons can move through a wire 1209 to an electrical load 1210 to accomplish the desired work where the electrons then travel on wire 1211 to the cathode can where they participate in the cathodic reaction. The electrode structures and features described below may be used in place of, or in combination with electrode of FIG. 20 in a cell such as that of FIG. 21.

FIG. 22 shows a coated plate 1300 in cross section. The plate 1300 shows a two-dimensional surface, which is simply an example of a surface, which could have any shape, including a smooth curved surface, or even a highly irregular or regular surface such as a reticulum. A first layer 1300 is a metal from one of many metal groups, which may include, but are not limited to, cold rolled steel, stainless steel or nickel. In other embodiments, it may be silver, copper, brass, bronze or any other suitable metal. A second layer 1301 is metal, which may include electroplated nickel. In other embodiments, the metal may include, but is not limited to, gold, silver, tin, indium or alloys thereof. A third layer 1302 is co-electroplated with the second layer 1301 resulting in particles being entrapped and embedded within the second layer with some of the particles exposed at the surface. In one embodiment, the co-electroplated powders may be less than 1000 nanometers. In other embodiments, the powders may be less than 100 nanometers or less than 20 nanometers. In another embodiment, the third layer may be composed of a mixture of different metals and different sizes ranging from low nanometers to as great as 50 micrometers. This nano catalyst may be any one of the transition metals, their alloys or oxides thereof. Preferably they may include nickel, cobalt, iron and manganese among others.

In an embodiment, Teflon® powder is added in the form of DuPont Teflon emulsion TE 3859, which is co-electroplated with the catalytic powders at a loading of about 9% of the catalytic powder weight. That is, the Teflon powder is mixed with catalyst powder in the electroplating solution during electroplating such that the Teflon is incorporated on the surface of the resulting electrode. The Teflon may also be partially embedded with the electroplating metal.

FIG. 8A illustrates the shape of the pulsed plating current embodiments for fabricating bifunctional electrodes. This waveform is discussed above. The plating power supply is connected to the electrodes with the negative connected to the conductive panel intended to be coated and the positive to the anode counter electrode composed of essentially pure nickel. The wave shape during co-plating may be roughly rectangular and may be have a more complex waveform than shown. The frequency can be from 100 to 10000 hertz, preferably 500 to 1000 hertz with and average “ON” current of about −0.175 Amps/cm2 with a maximum peak of about −0.350 Amps/cm2. This is followed by a short 0.175 Amps/cm2 followed by resting at 0 Amps/cm2 for the remainder of the cycle. The overall duty cycle averages −0.090 Amps/cm2 with a duty cycle of 50% and lasts for five minutes. FIG. 8A is an example of this reverse pulse wave-shape.

FIG. 23 illustrates a porous 3D coated electrode 1401. An active body 1402 is composed of a current collector 1403 composed of nickel or nickel electroplated steel or some other suitable material having a high surface area to volume ratio such as a porous material such as metal foam or a reticulum of irregular or regular structure, woven or nonwoven metal fabric in one or multiple layers, metal fiber mat. The surface of the current collector is coated with a multiphase layer on the substrate including particles (for example nano or mixed nano and micron scale particles) and a metal matrix where at least some of the particles are partially embedded in the metal matrix to secure them to the substrate and partially exposed to render them active catalytically by exposing them to air and electrolyte. Thus, the partially exposed surface of the particles may define, in the aggregate, a catalytically active surface of the electrode. To allow air to reach the highly rough surface of the coated current collector, a web of PTFE or other hydrophobic material lies in intimate contact catalytic surface essentially defining a surface hydrophobic network to enable the diffusion of gases. The multiphase coating of catalyst particles and metal matrix along with the hydrophobic web or matrix may substantially fill the void space 1404.

There can be any number of catalysts used in the multiphase coating. The mixture may have five to ten catalysts included. Some of these catalysts are useful for the reduction of oxygen, some are specific to the oxidation of oxygen to nascent oxygen and still others are useful in both functions. On an air side, a hydrophobic moisture barrier 1405 may be provided. The moisture barrier 1405 may be composed of unsintered porous Teflon film. It may be attached by pressure lamination to the active body 1402 of the electrode. A thin layer of Teflon® emulsion such as T30b may be sprayed onto the surface of the active layer prior to lamination to improve the bond strength. A second uncompressed sheet of Teflon® 1406 may be used as a gasket toward the airside of the electrode. On an anode side, electrode unit may be isolated from the metallic anode by some electrically insulating but ionically conductive separator 1407.

To create the structure of FIG. 23, the multiphase coating may be created by coplating with an electroplating solution with a mixture of catalyst particles and PTFE particles. The electroplating process attaches the particles to the surface of the current collector. The process may be repeated until a desired layer thickness is achieved. Alternatively, the PTFE may be added after the multiphase layer is provided by coplating. The PTFE may be added by coplating or my some other means such as flowing a suspension into the interstices of the current collector. In either case, the entire structure may be compressed to fibrillate or bind the PTFE particles together thereby forming a PTFE network or web. Examples of method of creating an electrode with a structure as shown in FIG. 23 are given below but the disclosed embodiments are limited to the particular examples.

In an embodiment, a bifunctional gas electrode effectively, and to some degree, separates the functions within the electrode body 1402 by positioning a catalyst which encourages oxygen evolution on the side closest to the hydrophobic film 1405 and a catalyst better suited for oxygen reduction on the side closest to the separator 1407. See Table 4 below and attending discussion. The PTFE loading may also be graded so that it is higher on the side adjacent the hydrophobic film 1405. Catalysts useful for both discharge and recharge can be evenly distributed. Density would also be best if it were higher toward the separator 1407.

FIGS. 24A, 24B, 24C, and 24D are photographs of a 3D bifunctional electrode in various states of fabrication. A coated current collector is shown in FIG. 24A with nano nMnOx and Teflon powder applied through a co-plating process. FIG. 24B shows a close-up view of this coated foam electrode. FIG. 24C shows this electrode after compression resulting in densification of the mix and fibrillation of the Teflon particles. FIG. 24D is a finished electrode with Teflon film laminated to it.

FIG. 25 illustrates the use of a coated 3D bifunctional electrode to build a bifunctional Zinc Air cell 1501. The cathode 501 is described in FIG. 23 and is situated at the bottom of the cathode can 1502 which has air access holes 1503 sized to allow enough air into the cell to facilitate the intended function of the cell. This can is composed of nickel; nickel-electroplated steel or nickel-electroplated stainless steel. The anode cap 1504 is composed of several layers, usually nickel on the outside, stainless steel on the inner layer and copper being exposed to the metallic anode fuel 1505. The inner surface of the cap can be copper, brass, bronze or tin. Both the can and cap may be of plastic components with electrical leads being attached to the cathode and a current collector added to the anode compartment. The anode 1506 contains a strongly alkaline electrolyte 1507 such as about 33% potassium hydroxide, sodium hydroxide or a mixture of the two. The anode fuel 1505 is a reduced metal such as zinc, aluminum or magnesium. The anode cap and cathode can are separated from each other with a plastic grommet 1508. This grommet may be composed of Nylon 66 or polysulfone and is usually coated with a sealant.

In the discharge mode within the cathode 1501, oxygen is consumed reacting with water and releasing hydroxyls into the electrolyte by the reaction H₂O+½O₂+2e⁻→2OH⁻. The anode fuel uses these hydroxyls to oxidize the reduced metal. In the case of zinc, the reaction is Zn+2OH⁻→ZnO+H₂O+2e⁻. The liberated electrons collect on the anode cap making it negatively charged. These electrons can move through a wire 1509 to some load 1510 to accomplish the desired work where the electrons then travel on wire 1511 to the cathode can where they participate in the cathodic reaction.

In the recharge mode within the cathode 501, nascent oxygen and a water molecule are generated by the reaction 2OH⁻→H₂O+½O₂+2e⁻ within electrode 502 when electrons are drawn out of the cathode by the recharging circuit 1510. This nascent oxygen combines with a neighboring oxygen atom to form a diatomic oxygen molecule and escapes through the two Teflon® films 505 and 506 by diffusion.

The spent anode fuel (ZnO) 1505 uses the supplied electrons from the charging source 1510 to produce a reduced zinc atom and two hydroxyls, which migrate to the cathode by the reaction is ZnO+H₂O+2e⁻→Zn+2OH⁻. These electrons are supplied by a source 1510, which replaces the load.

FIG. 26 illustrates a half-cell apparatus that may be used in testing air-breathing electrodes. Shown is a half-cell apparatus 1601 built from some stable plastic such as Acrylic, PVC, Teflon® or Nylon 1610 and a simplified block diagram of a potentiostat 1602. The two work together to test the electrochemical activity of the air electrode. The physical layout consists of the test electrode 1603, which reduces oxygen from the environment or an oxygen source when electrons are supplied to that electrode (to be discussed in more detail below). These hydroxyls diffuse into the electrolyte 1604. There is a reference compartment 1607 which is in ionic contact at 1608 with the edge of the working electrode 1603 which has exactly one square centimeter of surface exposed to the electrolyte at 1604. A pure zinc wire was used as the reference 1609 because it is easy to use, is very stable in strong alkaline electrolytes and the value is well known in the field. Any alkaline-stable reference can be used. In the counter chamber 1607 there is a coil of platinum screen brazed to a gold or silver wire that acts as a counter electrode 1611. The oxygen generated 1612 escapes through a counter exit port 1613.

To understand the function of the circuit with the half-cell apparatus, consider a voltage scan in the cathodic direction, which reduces oxygen. Within the working electrode 1603. The two sensing circuits are the voltage sensor 1614 which monitors the voltage between the reference wire which always has exactly zero current flowing through it due to the very high input impedance of the operational amplifier (op-amp) 1615. The other sensor monitors the current flowing through the circuit 1616. A downward ramping voltage is generated from some external circuit 1617 and communicates with the non-inverting input of the operational amplifier 1615. This forces the output of the op-amp to be driven downward which draws electrons into that circuit. A power boosting output stage is also included, but not shown for simplicity. As electrons are drawn out, the reaction at the platinum counter electrode proceeds with 2OH⁻→H₂O+½O₂+2e⁻. This consumes hydroxyl ions from the electrolyte, releases a water molecule (which migrates toward the cathode) and oxygen is released into the electrolyte 1612 escaping through port 1613. This consumption of ions caused a flow of ions from the cathode electrode to the anode chamber 1606. This draws the hydroxyls from the working test electrode by H₂O+½O₂+2e⁻→2OH⁻, which draws electrons from the circuit ground 1618. By doing so, the voltage measured between the working electrode and the reference wire is reduced in potential. With the voltage controller 1617 in a continuous downward ramp, this progresses as long as the experimenter wishes, usually about 800 mV below the Open Circuit Voltage (OCV). Of course, all aspects of this series of events are taking place essentially simultaneously, but explained here in a linear fashion for comprehension.

To run an Oxygen evolution (i.e.: recharge cycle or anodic) scan, one simply programs the electrical controller 1617 to move slowly from the initial voltage to some higher value rather than scanning downward. The scan rate used here is always 1 mV/sec to keep conditions essentially at steady state. Scanning anodically forces the reaction 2H₂O+2e⁻→H₂+2OH⁻ at the platinum counter electrode 1611 with the hydrogen gas 1612 escaping through the exit port 1613 and 2OH⁻→H₂O+½O₂+2e⁻ at the working electrode 1603 with the resulting nascent oxygen, having only its neighboring nascent oxygen with which to combine, forming diatomic oxygen and migrating to the vent hole 1503.

FIG. 9 is Voltammogram of a production air cathode used for zinc air batteries. It demonstrates that any cathode is a bifunctional electrode, but degradation is a serious problem after anodic discharge. In this graph, the voltage versus the zinc reference wire 1609 at Open Circuit is the starting point for the scan. The voltage is programmed at 1617 to decrease at 1 mV/sec until a value of 0.6 volts was achieved. The current is allowed to float being monitored at 816, showing whatever amount was needed to maintain the applied potential. Several anodic scans were then done (not shown) totally 250 Coulombs/cm2. This is equivalent to 100 mAmps for 42 minutes. Then the second cathodic scan was done. The degradation was due to active area loss since the nascent oxygen was being produced at the reaction sites that were needed for the second scan but being carbon, were corroded away as CO2. At the 1 volt level, the reduction in current density dropped from 511 mA/cm2 to just 66 mA/cm2 after the bifunctional performance.

The catalytic nano and micron powders found in the literature for bifunctional electrodes includes many transition metals from groups 3-16 and more specifically; are composed of nickel, iron, manganese, cobalt, tin, tungsten, platinum, gold and silver, or combinations, alloys, and oxides thereof. Catalyst examples listed in the literature for a bifunctional gas electrode includes but is not limited to compounds in Table 4.

TABLE 4

| | O₂ | O₂ |
|---|---|---|
| Some Catalyst Compounds | Reduction | Evolution |
| Carbon with 2% CoTMPP | X | |
| FeWO₄ | X | X |
| Perovskites (La_{0.6} Ca_{0.4} CaO₃) | X | |
| Co_{y}Oₓ | X | |
| WC-12% Co | X | |
| NiS | X | |
| NH₄HCO₃ | X | |
| Carbon with 2% CoTMPP + 8% Ag | | X |
| Perovskites (La_{0.6} Ni₃ Co_{0.1} O_{y}) | | X |
| WC-12% Co | | X |
| NiS | | X |
| NH₄HCO₃ | | X |
| Ag | X | X |
| La₂O₃ | X | X |
| MnO₂ | X | |
| MnSO₄ | X | X |
| SnO₂ | X | |
| Spinels (AB₂O₄ with A = divalent | X | X |
| and B = trivalent metals) | | |
| Ag₂O | X | X |
| WC | | X |
| WS₂ | | X |
| Ag₂O | X | X |
| Co₃O₄ | X | |
| CoWO₄ | | X |
| Fe₂O₃ | X | |
| FeWO₄ | | X |
| Teflon | Facilitator | Facilitator |

The reticulate metal foam may also include transition metals and is more preferably iron, steel, stainless steel, nickel, silver and alloys of these metals. The substrate and the catalysts do not need to be similar.

To use nano catalysts in a gas electrode, one first must coat some current collecting conductive surface with these catalytically active particles in a way that does not impede the flow of electrons and is tenacious enough to hold fast under the highly corrosive evolution of nascent oxygen during the recharging cycle of a bifunctional metal-air battery application. Examples for current collector materials in alkaline systems include nickel, and nickel-plated stainless steel, for the cathode. These metals could also be clad or electroplated on any other base metal.

Coating of the surface with catalytic particles has been accomplished with some success by several methods, but not cost effectively and often not in a robust fashion. Examples are techniques patented by Quantum Sphere Incorporated (QSI) and General Electric (GE) among others. This disclosure teaches a method to accomplish a strong, permanent and inexpensive way to attach catalytically active nano particles to a conductive surface useful for electrochemical activity such as water electrolysis, alkaline fuel cells or bi-functional gas electrodes among other applications.

Coatings on a flat plate Panel were used to study the concept and prove catalytic activity of the coating process. This facilitated a known 2D surface area for electrochemical evaluations. The base material was nickel 200 but could have been copper, brass or stainless steel. To this panel, a nickel lead wire was spot-welded.

Many factorial and linear experiments were run to determine the best current densities, temperatures, bath formulation and bath designs were studied for the coating process. At the time of this writing, 138 individual experiments have been logged to identify the best performance.

The Panel was electro-cleaned using 25% NaOH electrolyte heated to 65° C. and driven cathodically at about 0.1 Amps/cm2 for about one (1) minute. This cleans any residual organics off the metallic surface. The sample is then rinsed in distilled water and dipped into neutralizing acid bath composed of Sodium Bifluoride acid at room temperature for about a minute.

A room temperature plating bath was prepared composed of about 30% nickel chloride (NiClsub2) and 3% boric acid to achieve a pH of about 1.0. This bath can be purchased pre-mixed from Rio Grande #335-086. This solution is known in the plating profession as a “Wood's Strike” after the man who developed the method. Alternatively, hydrochloric acid can be used to reach the same pH. A nickel anode is used and current is applied at about 25 mA/cm squared for three (3) minutes. This plating forces a thin coating of nickel resulting in a pristine surface for further coatings. It may be beneficial to pulse the current to 50 mA/cm squared at a 50% duty cycle for three (3) minutes. A short negative pulse may also be used in the plating program. This wave-shape delivers a very smooth coating of nickel on the collector surface but the DC method is also acceptable.

A “Bright Nickel” plating bath is prepared composing of about 30% Nickel Sulfate, about 4.5% Nickel Chloride, about 3.5% Boric Acid and a small amount of Sodium Saccharin. This bath can be purchased pre-mixed from Rio Grande #335-078. This bath is held at about 65° C. A solution of 10% sulfuric acid is used to maintain a pH of about 4 to 5.

Catalyst and Teflon® powders were added to the plating bath at a loading of about 1% of the total bath weight. It is best to be above 0.5% of the bath weight. In this embodiment, these catalysts was only nano MnOx but could have contained any number of catalytically active powders listed in Table 4 above. If any agglomeration is observed in the dry powder (which should pour like a black liquid) then mortar and pestle or other milling process may be necessary prior to addition to the plating bath. Alternatively, the nano powders may be mixed with enough bath liquids to fully suspend them (˜25 w/w) followed by ultrasonic agitation. This mixture is then added to the plating bath resulting in a 1% w/w final combined loading. The mixture is well agitated using a small high-sheer blender.

The resulting bath containing the powders is heated to 65 degrees Celsius and agitated using a small hand-held mixer of the type used to froth cream or any other low-energy mixing device. Air agitation is an alternative method or simply bath circulation works well. The cleaned and “Wood's Strike” electroplated conductive surface is then held onto the bottom of the plating bath container by any suitable methods including a slotted rail at the bottom of the dish. As much as a minute of settling time is allowed as the nickel counter electrode is positioned at the bath surface above the electrode.

The plating power supply is connected to the electrodes with the negative connected to the conductive panel intended to be coated and the positive to the anode counter electrode composed of essentially pure nickel. The wave shape during co-plating needs to be roughly square and may be complex in nature. The frequency can be from 100 to 10000 hertz, preferably 500 to 1000 hertz with and average “ON” current of about −0.175 Amps/cm2 with a maximum peak of about −0.350 Amps/cm2. This is followed by a short 0.175 Amps/cm2 followed by resting at 0 Amps/cm2 for the remainder of the cycle. The overall duty cycle averages −0.090 Amps/cm2 with a duty cycle of 50% and lasts for five minutes. FIG. 8A is an example of this reverse pulse wave-shape.

While the current is off after the plating time, the plating bath is agitated using some mixing device or air agitation. Up to a minute is allowed for settling of the powders onto the electrode surface and current re-applied as before. This sequence is repeated up to 10 times for flat plates. Vigorous rinsing follows the last step to remove any loosely adhered particles.

Alternatively, the pulsed current may be left on continuously with periodic re-agitation of the bath at about 5 minute intervals until the desired loading of powders is reached. In this example, a total of 30 minutes of coating time was applied with five agitation steps.

Each co-plating application as described above was repeated many times. At the time of this writing, five applications of 6 minutes each are being used, with solution agitation between applications. The sample was then inverted and five more coatings applied. Alternatively, a circulating bath may be used which stops circulation when current is being applied with some short rest prior to reapplication of the current. Still another method that proved functional was to leave the current pulses on continuously, but apply a short agitation step every five minutes.

After the final co-plating application is applied, a vigorous rinsing step is employed to wash off any poorly adhered particles. Weighing the finished part after drying reveals the percent of the electroplated material that has been captured.

An example embodiment coats a substrate of INCO foamed nickel with 1450 g/m2 density and 4.5 mm thick and a pore size of about 600 um diameter. This material is reticulate foam with interconnected pores and a very high pore volume. It could have been other highly porous metal arrangements like the anisotropic metallic “paper” made by cross-bonded fine nickel mats. For this example the process was repeated ten times at 5 minutes each on each side of the 25 cm² electrode for a total of 20 applications. The recipe used in this example was 1% by bath weight nano MnOx from Quantum Sphere, Inc of Santa Anna, Calif. and 0.1% by bath weight Teflon particles from DuPont TE3859. Table 5 shows the Current Density (CD) recorded initially, after 250 Coulombs and in the case of example 2, after 6200 more Coulombs were anodically run through the electrodes. That is equivalent to 17 hours of discharge at 100 mA/cm² with no degradation.

TABLE 5
1 Volt CD

| | Example 1 | Example 2 | Example 1 | Example2 |
|---|---|---|---|---|
| Initial | 511.5 | 0.267 | 100% | 100% |
| After 250 Coulombs | 66.3 | 2.26 | 13% | 846% |
| After 6200 Coulombs | N/A | 2.31 | N/A | 865% |

In any of the foregoing method embodiments, in addition to agitating the plating bath, which may be conveniently done with an ultrasonic transducer attached to the plating anode, the plating bath may be forcibly circulated. In an embodiment, the flow through substrate (or previously coplated substrate) is sufficiently sealed around its perimeter to allow for forced convection of plating bath solution through it. This procedure ensures that coplating of particles and plating metal are provided within the interstices and channels defined by the flow through substrate (including any coatings thereon). In an example, the substrate is sealed to a plenum at the bottom of a plating bath which is agitated in any of the ways described herein. A pump draws plating solution containing particles from the plenum and returns them to the bath covering the substrate and plenum. An agitator keeps particles in suspension in the bath covering the plenum and substrate. By negatively pressurizing the plenum, the substrate may be held in place without the need for an additional sealing member being secured to the perimeter thereof. This variation may be applied to any of the embodiments disclosed herein.

In any of the foregoing embodiments, including electrolyzer embodiments, fuel cell embodiments, electrochemical device embodiments, one ore more vibrators, including one operating in the ultrasonic range, may be attached directly or indirectly to any or all electrodes and activated continuously or intermittently to release bubbles from the electrode surfaces. Such a vibrator may include an electromechanical transducer such as a piezoelectric device or a mechanical device such as a voice coil with either driven by a suitable oscillator circuit. Also a rotary motor driven device one with a offset mass on its rotor may be used. The list of oscillators is not limiting of the types that may be used, but merely some examples. The vibrator may be attached to the chamber or directly to the electrode, for example to an insulator attached to the terminal.

Fuel cells, bifunctional electrodes, and electrolyzers may be operated in pulsed fashion to enhance effectiveness. For example, a switching circuit may be used to connect and disconnect a load to a fuel circuit or bifunctional electrode cell according to the disclosed subject matter. The switching cycle may be, for example a fraction of a hertz to megahertz. Multiplexing of the load or supply current to all or subgroups of cells may result in smooth DC output while individual cells experience a desired pulsed current flow.

The gas-generating embodiments, and/or components thereof, of the disclosed subject matter may be used for processes other than hydrogen/oxygen generation. For example, the embodiments may be employed in the production or methane or ammonia according to known electrochemical processes. Suitable modifications of the embodiments are considered within the scope of the disclosed subject matter.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The foregoing description is that of preferred embodiments having certain features, aspects, and advantages in accordance with the present disclosed subject matter. Various changes and modifications also may be made to the above-described embodiments without departing from the spirit and scope of the disclosed subject matter. It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An electrode, comprising:
a substrate;
a multiphase layer on the substrate including particles, of at least one size, and a metal matrix;
at least some of the particles being at least partially embedded in the metal matrix such that partially exposed surfaces of the particles, and/or portions of the metal matrix covering the at least some of the particles, define, in the aggregate, a catalytically active surface of the electrode whose roughness is determined by the at least one size of the particles;
an electrical terminal connected to the substrate;
the substrate being configured to collect charge carriers from the particles over the catalytically active surface and deliver them to the electrical terminal.

2. The electrode of claim 1, wherein a fraction of the particles have a maximum dimension of less than 1 micron in diameter.

3. The electrode of claim 1, wherein the particles are of a metal.

4. The electrode of claim 1, wherein the substrate is substantially formed of cold-rolled steel, stainless steel, nickel, copper, brass, silver or alloys thereof.

5. The electrode of claim 1, wherein the substrate has a substantial isotropic void volume.

6. The electrode of claim 5, wherein the substrate includes metal foam and the metal matrix covers interstitial spaces in the metal foam.

7. (canceled)

8. The electrode of claim 1, wherein the particles are nano-scale powders of transition metals of groups 3-16.

9. The electrode of claim 1, wherein the particles are nano-scale powders of nickel, iron, cobalt, silver, tin, chromium, manganese, palladium, platinum, combinations thereof, alloys thereof or oxides thereof.

10. The electrode of claim 1, wherein the particles are mostly metal particles having a diameter of less than about 100 nm.

11. The electrode of claim 1, wherein the particles are mostly metal particles having diameters ranging between 20 microns to 10 nm.

12. A method of making an electrode, comprising:
suspending metal, nanoparticles in an electrolytic plating solution;
electroplating a metal electrode substrate placed in the plating solution for a period of time until a surface of nano-scale roughness is achieved.

13. The method of claim 12, wherein the nanoparticles are of nickel, iron, cobalt, silver, tin, chromium, manganese, palladium, platinum, combinations thereof, alloys thereof or oxides thereof.

14. The method of claim 12, wherein the electroplating includes applying a pulsed voltage to the substrate.

15. The method of claim 12, wherein the electroplating includes applying a pulsed voltage to the substrate of such magnitude and such waveform that, in combination with the density of the suspension and the sizes of the nanoparticles, a surface results characterized by nanoparticles partially embedded in a metal matrix of electrodeposited metal results and such that the surface formed by the metal matrix is roughened by embedded ones of the nanoparticles and/or partially exposed surfaces of the nanoparticles, which together define a catalytically active surface.

16. The method of claim 12, wherein the metal electrode substrate is a reticular member with a substantial void volume.

17. The method of claim 16, wherein the metal electrode is a sieve.

18. The method of claim 12, wherein the electroplating includes electroplating nickel, copper, gold, silver or tin.

19. The method of claim 12, wherein the nanoparticles have a mean size of less than about 100 nm.

20. The method of claim 12, wherein the suspending includes suspending micron particles as well as nanoparticles, together having a mixture of effective diameters from 20 microns to 10 nm.

21-92. (canceled)

93. The method of claim 14, wherein applying a pulsed voltage to the substrate includes applying a negative voltage and subsequently applying a positive voltage.
